(19) United States
(12) Patent Application Publication
(10) Pub. No.: US 2023/0380554 A1
(43) Pub. Date: Nov. 30, 2023

(54) DIAMONDS COATINGS AND METHODS OF MAKING AND USING THE SAME

(71) Applicant: Glisten LLC, Beverly Hills, CA (US)

(72) Inventors: Moonhee Kim, Beverly Hills, CA (US); James Nathan Hohman, Beverly Hills, CA (US)

(21) Appl. No.: 18/362,366

(22) Filed: Jul. 31, 2023

Related U.S. Application Data
(63) Continuation of application No. PCT/US2022/014917, filed on Feb. 2, 2022.
(60) Provisional application No. 63/145,821, filed on Feb. 4, 2021.

(51) Int. Cl. A44C 17/00; G02B 1/14

(52) U.S. Cl. CPC A44C 17/007; G02B 1/14

(57) ABSTRACT

Disclosed herein are chemically configurable diamonds tailored for self-cleaning, dirt repelling, and anti-smudge technology for sensing, optical, and ornamental applications. This document describes an invention for generating chemically configurable diamonds. Applications include anti-smudge, self-cleaning, color alteration, and debris resistance for diamond for jewelry or other ornamentation, optical, quantum computing, for chemical functionalization for sensors or electronic devices that rely on chemical interactions with diamonds or defects therein. Diamond surfaces are chemically inert and therefore require chemical modification to attach secondary coatings. Secondary coatings can be varied depending on application demands. Chemical reactions are employed to modify the surface wetting properties of the diamond. The wetting properties of the diamond can lend a hydrophilic, hydrophobic, lipophobic, or lipophilic effect to the diamond, or include explicit chemical functionality, depending on the nature of the coating, and tailored to the desired application. The coated diamond is constructed by fabricating a functional base layer on the diamond and subsequently attaching the desired chemical monolayer or multilayer to that base.

### CROSS REFERENCE TO RELATED APPLICATIONS

This application is a continuation of PCT Application No. PCT/US2022/014917, filed Feb. 2, 2022, and claims the benefit of U.S. Provisional Application No. 63/145,821, filed Feb. 4, 2021, which are incorporated in their entirety herein by reference.

### FIELD

This disclosure relates generally to coatings for different articles, such as jewelry (e.g., diamonds), lenses (e.g., for glasses, sunglasses, magnifying lenses, etc.), or other goods and methods for making and using the same. The coatings resist oil, dirt, and grime build-up.

### BACKGROUND

### Description of the Related Art

Over time, gemstone surfaces (e.g., the surface of a diamond or other gemstone), can attract dirt and grime. Dirt and grime can dull the appearance of the gemstone.

### SUMMARY

The highly non-reactive, hydrophobic hydrocarbon surface of a diamond attracts oil and grime. Thus, diamond surfaces become soiled quickly after cleaning. This soiling causes diamonds to lose their brilliance, luster, and fire, making them less attractive to wearers. Diamond brilliance creates the white sparkle of a diamond. It makes it seem like light is pouring out of the diamond. Diamond fire causes the rainbow colored sparkle some diamonds may have. The reflection of white light inside a diamond is diamond brilliance. Diamond fire is the diffraction of white light into a rainbow of colors. It's similar to how a rainbow is formed after a rainstorm. Soiling causes a loss of these and other beneficial properties of diamonds.

The non-reactive surface of diamonds also make them particularly difficult to functionalize. For instance, while silane chemistry is a potential avenue to introduce anti-soiling properties to the surface of a jewelry diamond, the diamond surface is not reactive enough to covalently couple sufficiently to silanes to allow effective coating. While silanes can be used to prepare monolayers on surfaces such as glass and plastic, the covalent bonding of a silane to a surface requires the surface be regular and nucleophilic. The nucleophilic groups on the surface displace leaving groups on the silane atom, bonding the silane to the surface. While this process is practical for functionalizing surfaces having nucleophiles already present, on surfaces that lack nucleophilic groups (or lack a sufficient density or amount of nucleophilic groups), silanization cannot be accomplished to an appreciable, effective, and/or useable degree. In the case of gemstones, such as diamond, the surface lacks sufficient reactivity to provide regular and dense silanization (and coating formation). Also problematic is the expense associated with jewelry grade diamonds. Because jewelry grade diamonds are expensive, scientists have been reluctant to diamonds to processing and/or functionalizing conditions.

Disclosed herein are methods of covalently coating substrate surfaces (e.g., gemstone surfaces, especially diamond surfaces, etc.) with silanes. Some embodiments disclosed herein solve the above problems and/or other challenges associated with preparing a covalently bonded, anti-soiling layer on a surface (e.g., functionalizing surfaces with silanes). In several embodiments, a multistep surface preparation is performed to achieve a surface with sufficient reactivity to allow effective coating using silane chemistry. Some embodiments pertain to substrates having surfaces where high optical quality is desired (e.g., diamonds, gemstones, lenses, etc.). Some embodiments pertain to substrates, such as gems (e.g., diamonds), with a surface comprising a silane having an anti-soiling substituent (e.g., a tail). In several embodiments, the silane comprises one or more anti-soiling substituents (e.g., tails). In several embodiments, the gem comprises a molecularly coated surface. In several embodiments, the tail (or tails) of the silane confer upon the gem anti-soiling properties.

In several embodiments, prior to silanization, the diamond surface (or other surface) is prepared. In several embodiments, the surface is plasma treated. In several embodiments, surprisingly, it has been found that plasma treatment and coating of a diamond surface does not significantly impact the optical properties of the diamond. That a diamond (or other article) can be plasma treated and coated without significant loss of optical properties is especially feature is surprising considering that plasma treatment utilizes conditions that are so harsh that they actually chemically change the surface of the diamond (or other article). In several embodiments, the plasma treatment is performed using oxygen plasma. In several embodiments, the plasma treatment is performed using hydrogen plasma. In several embodiments, the plasma treatment may include multiple plasma treatment steps. For example, in several embodiments, the plasma treatment process includes exposure to a first type of plasma (e.g., oxygen plasma), followed by exposure to a second type of plasma (e.g., hydrogen plasma).

In several embodiments, the plasma treated surface is annealed using water vapor. In several embodiments, surprisingly, it has been found that annealing process also does not significantly impact the optical properties of the diamond. In several embodiments, after annealing, the diamond is coated with a silane layer (silanized) through reaction with a silanizing group. In several embodiments, the silanizing group (e.g., which comprises a silane unit) is an alkoxysilane or halosilane comprising at least one tail group. In several embodiments, the silane unit comprises an optionally substituted alkyl group as a tail (e.g., a haloalkyl). In several embodiments, surprisingly, it has been found that silanization process also does not significantly impact the optical properties of the diamond.

Several embodiments disclosed herein provide a soil resistant surface (e.g., a gemstone surface). In several embodiments, surface is that of a gemstone. In several embodiments, the gemstone is a diamond. In several embodiments, the diamond comprises a jewelry grade diamond gemstone having an anti-soiling surface coating. In several embodiments, the anti-soiling surface coating is covalently bonded to the diamond. In several embodiments, the anti-soiling surface coating comprises, consists of, or consists essentially of a monolayer. In several embodiments, the diamond surface and monolayer is represented by Surface (I):

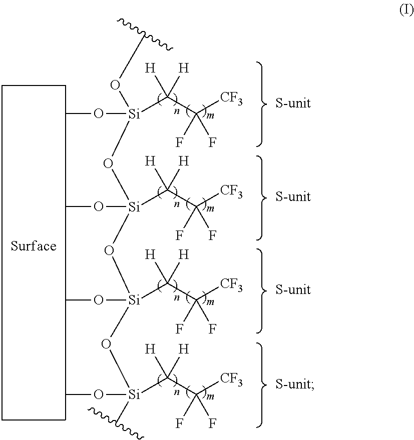

In several embodiments, n is an integer selected from 0, 1, 2, 3, or 4. In several embodiments, m is an integer ranging from 1 to 15.

Several embodiments pertain to a soil resistant gemstone (e.g., diamond) prepared by a method. Several embodiments pertain to a soil resistant surface represented by Surface (I) prepared by a method. Several embodiments pertain to a method of preparing a soil resistant gemstone (e.g., diamond). In several embodiments, the soil resistant diamond is prepared by plasma treating a surface of a raw diamond to provide a precursor diamond having a precursor diamond surface. In several embodiments, the precursor diamond surface is chemically different than the surface of the raw diamond. In several embodiments, the method comprises annealing the precursor diamond to provide a reactive diamond having a reactive diamond surface. In several embodiments, the reactive diamond surface is different from the precursor diamond surface. In several embodiments, the method comprises exposing the reactive diamond surface to a silanizing agent comprising an S-unit. In several embodiments, each “S-unit” is a silane unit comprising of Si(CH₂)ₙ(CF₂)ₘCF₃.

In several embodiments, the surface of the raw diamond comprises hydroxyl groups, carbonyl groups, carboxylic acid groups, epoxide groups, C—H groups, and C—C groups, as represented in Surface (I-r) by groups A¹, A², A³, A⁴, A⁵, and A⁶, respectively:

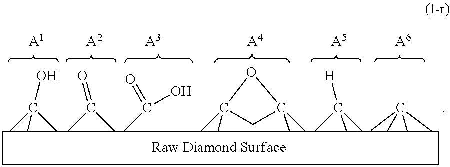

In several embodiments, the a contact angle for water on the surface of the raw diamond ranges from 350 to 60°.

In several embodiments, the precursor diamond surface comprises a ratio of A¹ and A⁵ groups relative to a total number of surface groups A¹ to A⁶. In several embodiments, the ratio is quantitatively calculated as (A¹+A⁵)/(A¹+A²+A³+A⁴+A⁵+A⁶). In several embodiments, this ratio is qualitatively calculated (e.g., using FT-IR, FTIR ATR spectroscopy, or other spectroscopic techniques). In several embodiments, the ratio of A¹ and A⁵ groups relative to a total number of surface groups A¹ to A⁶ for the precursor diamond surface is higher than the ratio of A¹ and A⁵ groups relative to a total number of surface groups A¹ to A⁶ for the raw diamond surface. For example, where the ratio of (A¹+A⁵)/(A¹+A²+A³+A⁴+A⁵+A⁶) on the surface of the precursor diamond equals Ratio^{Precusor(1,5)} and where the ratio (A¹+A⁵)/(A¹+A²+A³+A⁴+A⁵+A⁶) on the surface of the raw diamond equals Ratio^{Raw(1,5)}, in several embodiments, Ratio^{Precusor(1,5)}>Ratio^{Raw(1,5)}.

In several embodiments, a contact angle for water on the precursor diamond surface ranges from 300 to 55°.

In several embodiments, the reactive diamond surface comprises a ratio of A¹ groups relative to a total number of surface groups A¹ to A⁶. In several embodiments, the ratio is quantitatively calculated as (A¹)/(A¹+A²+A³+A⁴+A⁵+A⁶). In several embodiments, this ratio is qualitatively calculated (e.g., using FT-IR, FTIR ATR spectroscopy, or other spectroscopic techniques). In several embodiments, the ratio of A¹ groups relative to a total number of surface groups A¹ to A⁶ for the reactive diamond surface is higher than the ratio of A¹ groups relative to a total number of surface groups A¹ to A⁶ for the precursor diamond surface. For example, where the ratio of (A¹)/(A¹+A²+A³+A⁴+A⁵+A⁶) on the surface of the precursor diamond equals Ratio^{Reactive(1)} and where the ratio (A¹)/(A¹+A²+A³+A⁴+A⁵+A⁶) on the surface of the precursor diamond equals Ratio^{Precursor(1)}, in several embodiments, Ratio^{Reactive(1)}>Ratio^{Precursor(1)}.

In several embodiments, a contact angle for water on the reactive diamond surface ranges from 10° to 40°. In several embodiments, a contact angle for water on the reactive diamond surface ranges from 100 to 20°. In several embodiments, a contact angle for water on the reactive diamond surface ranges from 5° to 20°.

In several embodiments, n is 2. In several embodiments, n is 2. In several embodiments, m is between 6 and 12. In several embodiments, m is 8.

In several embodiments, each nm² of the soil resistant diamond surface comprises equal to or at least 2 S-units.

In several embodiments, the Surface (I) is further represented by Surface (I-i):

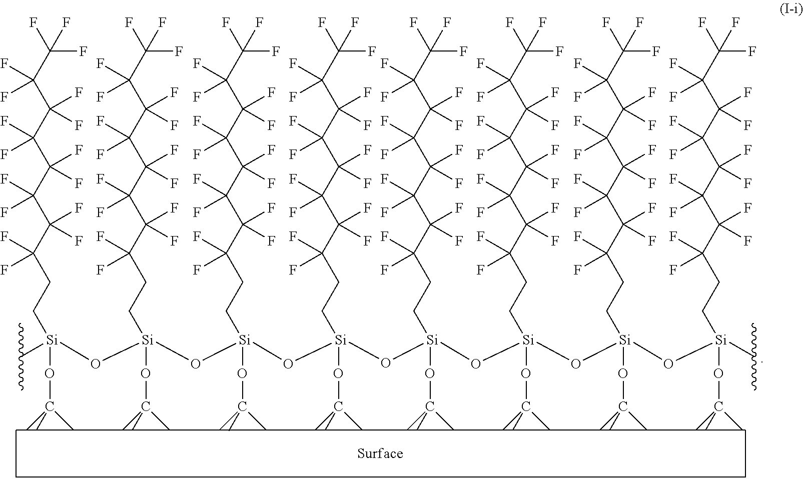

In several embodiments, the molecularly coated surface comprises Formula I:

S-A [symbol] T)ₚ Formula I

where S represents a surface of a gemstone (or another substrate) and -A(-T)ₚ represents the molecular coating; A is an silane or siloxane covalently bonded to S; T is a pendant moiety (e.g., a tail) bonded to A; p is an integer between 1 and 5; and wherein the coated surface has different physical properties and/or chemical properties than the surface prior to coating. In several embodiments, T is 1 or 2. In several embodiments, S is a plasma treated surface. In several embodiments, A comprises Si (e.g., —Si(O)ₓ— where x is 1, 2, 3, or 4). In several embodiments, A-T comprises T-Si(O)ₓ—, where x is 1, 2, or 3, and wherein each O is further bonded to a carbon of the surface or to an adjacent Si (e.g., of an adjacent T-Si(O)ₓ— unit). In several embodiments, T is an alkyl. In several embodiments, T is optionally substituted alkyl. In several embodiments, T is optionally substituted haloalkyl. In several embodiments, T is optionally substituted perflouroalkyl. In several embodiments, T is comprises an optionally substituted alkyl portion and an optionally substituted haloalkyl portion. In several embodiments, T is an C₁₋₁₀ alkyl (optionally substituted) or C₁₋₁₀ perfluoroalkyl (optionally substituted). In several embodiments, T is selected from the group consisting of n-octyl, heptafluoroisopropoxypropyl, nonafluorohexyl, tridecafluorohexyl, trifluoromethyl, or combinations thereof. In several embodiments, the surface is that of a diamond.

Some embodiments pertain to method of preparing the surface comprising exposing the surface to a reagent selected from: heptafluoroisopropoxypropyltrichlorosilane, heptafluoroisopropoxypropyltrimethoxysilane, bis(nonafluorohexyldimethylsiloxy)methyl-silylethyldimethylchlorosilane, tridecafluoro-2-(tridecafluorohexyl)decyltrichlorosilane, heneicocyl-1,1,2,2-tetrahydrodecyltrichlorosilane, (tridecafluoro-1,1,2,2-tetrahydrooctyl)trichlorosilane, (tridecafluoro-1,1,2,2-tetrahydrooctyl)methyldichlorosilane, (tridecafluoro-1,1,2,2-tetrahydrooctyl)dimethylchlorosilane, (tridecafluoro-1,1,2,2-tetrahydrooctyl)trimethoxysilane, (tridecafluoro-1,1,2,2-tetrahydrooctyl)triethoxysilane, (heptadecafluoro-1,1,2,2-tetrahydrodecyl)trichlorosilane, (heptadecafluoro-1,1,2,2-tetrahydrodecyl)methyldichlorosilane, (heptadecafluoro-1,1,2,2-tetrahydrodecyl)dimethylchlorosilane, (heptadecafluoro-1,1,2,2-tetrahydrodecyl)trimethoxysilane, (heptadecafluoro-1,1,2,2-tetrahydrodecyl)triethoxysilane, n-octyltrichlorosilane, or combinations thereof. In several embodiments, the method comprises exposing the surface to plasma treatment prior to exposure to the reagent.

Some embodiments pertain to a diamond made by the methods disclosed above and/or a diamond having a surface as disclosed above.

### BRIEF DESCRIPTION OF THE DRAWINGS

FIG. 1A is a representation of a raw diamond surface having various functional groups.

FIGS. 1B-1F are photographs and angular spectrum evaluation tool (ASET) images and SEM images of clean and soiled diamonds. FIGS. 1B and 1D show a photograph and an ASET image, respectively, of a clean diamond. FIGS. 1C and 1E show a photograph and an ASET image, respectively, of a dirty diamond. FIG. 1F shows a representative SEM image of a fouled diamond having dirt particles and grime accumulated (see arrows). The scale bars indicate 2 mm and 200 μm.

FIGS. 2A and 2B show schemes providing embodiments for functionalizing a substrate surface and a diamond surface, respectively. As shown in FIGS. 2A and 2B, respectively, the substrate and diamond surface can be subject to plasma treatment in Step A to provide a Precursor Surface on the substrate or diamond. As shown in FIGS. 2A and 2B, respectively, in Step B, the substrate and diamond surface can be subject to annealing with water to provide a Reactive Surface. As shown in FIGS. 2A and 2B, respectively, the surface of the substrate and diamond may be silanized in Step C to provide a coated substrate and coated diamond surface. The substituent R provides desired surface properties of the substrate and diamond, respectively. Natural, lab grown, and other diamond crystals have a mixture of chemical states. Treatment by hydrogen and oxygen plasma combined with a furnace treatment to convert surface hydrogen to oxygen-containing species renders the substrate receptive to coating.

FIG. 3 is a schematic showing an annealing apparatus and process. As shown, nitrogen gas can be bubble through ultrapure water to generate nitrogen and water vapor. The nitrogen and water vapor a passed into a furnace (e.g., electric furnace) where an article comprising a precursor article having a Precursor Surface (e.g., a Precursor Diamond Surface) is located. The furnace heats the vapor and the precursor article thereby depositing reactive oxygen species onto the substrate surface.

FIG. 4 shows a raw diamond in the left pane and a coated diamond in the right pane. To prepare the coated diamond, the raw diamond was modified to be hydrophilic by conversion of surface chemical sites to reactive oxygen species. In the right pane, the diamond has been functionalized with a silane comprising a perfluoroalkyl tail. The reactive oxygen species are receptive to subsequent coating.

FIG. 5 provides another scheme showing a two-step process for preparing a diamond with a soil resistant silane surface. In several embodiments, R is an optionally substituted alkyl. In several embodiments, R is an alkyl comprising a perfluorinated portion.

### DETAILED DESCRIPTION

Some embodiments disclosed here pertain to molecular coatings for gemstones (e.g., diamonds), methods of coating gemstones, and methods of using gemstone coatings to resist dulling of gemstones. In several embodiments, the gemstone is a diamond. In several embodiments, the molecular coating comprises a silane or siloxane molecule with a substituent (e.g., a tail) having a desired property. In several embodiments, the substituent alters the physical properties of the gemstone. For instance, in some embodiments, hydrophobic gem surfaces can be converted to hydrophilic surfaces using a hydrophilic host molecule. Conversely, in some embodiments, hydrophilic gem surfaces can be converted to hydrophobic surfaces using a hydrophobic host molecule. Alternatively, a hydrophilic, hydrophobic, or amphiphilic surface can be converted to an amphiphobic surface. In several embodiments, mixed surfaces (hydrophilic, amphiphilic, or hydrophobic) can be achieved through the selection of varying substituents. The following description provides context and examples, but should not be interpreted to limit the scope of the inventions covered by the claims that follow in this specification or in any other application that claims priority to this specification. No single component or collection of components is essential or indispensable.

Whenever a group is described as being “optionally substituted” that group may be unsubstituted or substituted with one or more of the indicated substituents. Likewise, when a group is described as being “unsubstituted or substituted” (or “substituted or unsubstituted”) if substituted, the substituent(s) may be selected from one or more the indicated substituents. If no substituents are indicated, it is meant that the indicated “optionally substituted” or “substituted” group may be substituted with one or more group(s) individually and independently selected from alkyl, alkenyl, alkynyl, cycloalkyl, cycloalkenyl, aryl, heteroaryl, heterocyclyl, aryl(alkyl), cycloalkyl(alkyl), heteroaryl(alkyl), heterocyclyl(alkyl), alkoxy, halogen, haloalkyl, haloalkoxy, an amino, a mono substituted amine group, a di substituted amine group, a mono substituted amine(alkyl), a di substituted amine(alkyl), a diamino-group, a polyamino, a diether-group, and a polyether-. An optionally substituted group may be perhalogenated (e.g., perfluoro). For instance, optionally substituted methyl may include —CF₃. Additionally, a substituent, when presented on an optionally substituted compound may be halogenated (e.g., fluorinated) and/or perhalogenated (e.g., perfluoro). For instance, optionally substituted ethyl may include an ethyl with a perfluorinated cycloalkyl as its optional substituent. For further illustration, optionally substituted ethyl may include perfluorinated ethyl with a perfluorinated cycloalkyl as its optional substituent.

As used herein, “Cₐ to C_{b}” in which “a” and “b” are integers refer to the number of carbon atoms in a group. The indicated group can contain from “a” to “b”, inclusive, carbon atoms. Thus, for example, a “C₁ to C₄ alkyl” group refers to all alkyl groups having from 1 to 4 carbons, that is, CH₃—, CH₃CH₂—, CH₃CH₂CH₂—, (CH₃)₂CH—, CH₃CH₂CH₂CH₂—, CH₃CH₂CH(CH₃)— and (CH₃)₃C—. If no “a” and “b” are designated, the broadest range described in these definitions is to be assumed. Similarly, C₁₋₄ alkyl has the same meaning as C₁ to C₄ alkyl.

If two “R” groups are described as being “taken together” the R groups and the atoms they are attached to can form a cycloalkyl, cycloalkenyl, aryl, heteroaryl or heterocycle. For example, without limitation, if R^{a} and R^{b} of an NR^{a}R^{b} group are indicated to be “taken together,” it means that they are covalently bonded to one another to form a ring:

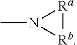

As used herein, the term “alkyl” refers to a fully saturated aliphatic hydrocarbon group. The alkyl moiety may be branched or straight chain. Examples of branched alkyl groups include, but are not limited to, iso-propyl, sec-butyl, t-butyl and the like. Examples of straight chain alkyl groups include, but are not limited to, methyl, ethyl, n-propyl, n-butyl, n-pentyl, n-hexyl, n-heptyl and the like. The alkyl group may have 1 to 30 carbon atoms (whenever it appears herein, a numerical range such as “1 to 30” refers to each integer in the given range; e.g., “1 to 30 carbon atoms” means that the alkyl group may consist of 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, although the present definition also covers the occurrence of the term “alkyl” where no numerical range is designated). The “alkyl” group may also be a medium size alkyl having 1 to 12 carbon atoms. The “alkyl” group could also be a lower alkyl having 1 to 6 carbon atoms. By way of example only, “C₁-C₅ alkyl” indicates that there are one to five carbon atoms in the alkyl chain, i.e., the alkyl chain is selected from methyl, ethyl, n-propyl, isopropyl, n-butyl, isobutyl, tert-butyl, pentyl (branched and straight-chained), etc. Typical alkyl groups include, but are in no way limited to, methyl, ethyl, propyl, isopropyl, butyl, isobutyl, tertiary butyl, pentyl and hexyl.

Any “alkyl” group disclosed herein may be substituted or unsubstituted. For instance, an alkyl disclosed herein may be substituted whether or not indicated as “substituted” or “optionally substituted”. Optional substitutions of alkyl groups may include those described elsewhere herein. For instance, where optionally substituted, an alkyl may be substituted with halogen atoms. To illustrate, an optionally substituted alkyl may be halogenated (having one or more —H atoms replaced by —X^{H}, where X^{H} is halogen). As an additional illustration, an optionally substituted alkyl may be perhalogenated (e.g., perfluorinated, where each —H atom is replaced with a —F) or partially halogenated.

As used herein, the term “alkylene” refers to a bivalent fully saturated straight chain aliphatic hydrocarbon group. Examples of alkylene groups include, but are not limited to, methylene, ethylene, propylene, butylene, pentylene, hexylene, heptylene and octylene. An alkylene group may be represented by [symbol] , followed by the number of carbon atoms, followed by a “*”. For example,

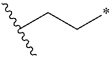 [SMILES: *CC*]

to represent ethylene. The alkylene group may have 1 to 30 carbon atoms (whenever it appears herein, a numerical range such as “1 to 30” refers to each integer in the given range; e.g., “1 to 30 carbon atoms” means that the alkyl group may consist of 1 carbon atom, 2 carbon atoms, 3 carbon atoms, etc., up to and including 30 carbon atoms, although the present definition also covers the occurrence of the term “alkylene” where no numerical range is designated). The alkylene group may also be a medium size alkyl having 1 to 12 carbon atoms. The alkylene group could also be a lower alkyl having 1 to 6 carbon atoms. An alkylene group may be substituted or unsubstituted. For example, a lower alkylene group can be substituted by replacing one or more hydrogen of the lower alkylene group and/or by substituting both hydrogens on the same carbon with a C₃₋₆ monocyclic cycloalkyl group

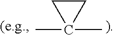

As disclosed elsewhere herein, where requiring to attachment points, an alkyl may be alkylenyl.

The term “alkenyl” used herein refers to a monovalent straight or branched chain radical of from two to twenty carbon atoms containing a carbon double bond(s) including, but not limited to, 1-propenyl, 2-propenyl, 2-methyl-1-propenyl, 1-butenyl, 2-butenyl and the like. An alkenyl group may be unsubstituted or substituted.

The term “alkynyl” used herein refers to a monovalent straight or branched chain radical of from two to twenty carbon atoms containing a carbon triple bond(s) including, but not limited to, 1-propynyl, 1-butynyl, 2-butynyl and the like. An alkynyl group may be unsubstituted or substituted.

As used herein, “cycloalkyl” refers to a completely saturated (no double or triple bonds) mono- or multi-cyclic (such as bicyclic) hydrocarbon ring system. When composed of two or more rings, the rings may be joined together in a fused, bridged or spiro fashion. As used herein, the term “fused” refers to two rings which have two atoms and one bond in common. As used herein, the term “bridged cycloalkyl” refers to compounds wherein the cycloalkyl contains a linkage of one or more atoms connecting non-adjacent atoms. As used herein, the term “spiro” refers to two rings which have one atom in common and the two rings are not linked by a bridge. Cycloalkyl groups can contain 3 to 30 atoms in the ring(s), 3 to 20 atoms in the ring(s), 3 to 10 atoms in the ring(s), 3 to 8 atoms in the ring(s) or 3 to 6 atoms in the ring(s). A cycloalkyl group may be unsubstituted or substituted. Examples of mono-cycloalkyl groups include, but are in no way limited to, cyclopropyl, cyclobutyl, cyclopentyl, cyclohexyl, cycloheptyl and cyclooctyl. Examples of fused cycloalkyl groups are decahydronaphthalenyl, dodecahydro-1H-phenalenyl and tetradecahydroanthracenyl; examples of bridged cycloalkyl groups are bicyclo[1.1.1]pentyl, adamantanyl and norbornanyl; and examples of spiro cycloalkyl groups include spiro[3.3]heptane and spiro[4.5]decane.

As used herein, “cycloalkenyl” refers to a mono- or multi-cyclic (such as bicyclic) hydrocarbon ring system that contains one or more double bonds in at least one ring; although, if there is more than one, the double bonds cannot form a fully delocalized pi-electron system throughout all the rings (otherwise the group would be “aryl,” as defined herein). Cycloalkenyl groups can contain 3 to 10 atoms in the ring(s), 3 to 8 atoms in the ring(s) or 3 to 6 atoms in the ring(s). When composed of two or more rings, the rings may be connected together in a fused, bridged or spiro fashion. A cycloalkenyl group may be unsubstituted or substituted.

As used herein, “aryl” refers to a carbocyclic (all carbon) monocyclic or multicyclic (such as bicyclic) aromatic ring system (including fused ring systems where two carbocyclic rings share a chemical bond) that has a fully delocalized pi-electron system throughout all the rings. The number of carbon atoms in an aryl group can vary. For example, the aryl group can be a C₆-C₁₄ aryl group, a C₆-C₁₀ aryl group or a C₆ aryl group. Examples of aryl groups include, but are not limited to, benzene, naphthalene and azulene. An aryl group may be substituted or unsubstituted. As used herein, “heteroaryl” refers to a monocyclic or multicyclic (such as bicyclic) aromatic ring system (a ring system with fully delocalized pi-electron system) that contain(s) one or more heteroatoms (for example, 1, 2 or 3 heteroatoms), that is, an element other than carbon, including but not limited to, nitrogen, oxygen and sulfur. The number of atoms in the ring(s) of a heteroaryl group can vary. For example, the heteroaryl group can contain 4 to 14 atoms in the ring(s), 5 to 10 atoms in the ring(s) or 5 to 6 atoms in the ring(s), such as nine carbon atoms and one heteroatom; eight carbon atoms and two heteroatoms; seven carbon atoms and three heteroatoms; eight carbon atoms and one heteroatom; seven carbon atoms and two heteroatoms; six carbon atoms and three heteroatoms; five carbon atoms and four heteroatoms; five carbon atoms and one heteroatom; four carbon atoms and two heteroatoms; three carbon atoms and three heteroatoms; four carbon atoms and one heteroatom; three carbon atoms and two heteroatoms; or two carbon atoms and three heteroatoms. Furthermore, the term “heteroaryl” includes fused ring systems where two rings, such as at least one aryl ring and at least one heteroaryl ring or at least two heteroaryl rings, share at least one chemical bond. Examples of heteroaryl rings include, but are not limited to, furan, furazan, thiophene, benzothiophene, phthalazine, pyrrole, oxazole, benzoxazole, 1,2,3-oxadiazole, 1,2,4-oxadiazole, thiazole, 1,2,3-thiadiazole, 1,2,4-thiadiazole, benzothiazole, imidazole, benzimidazole, indole, indazole, pyrazole, benzopyrazole, isoxazole, benzoisoxazole, isothiazole, triazole, benzotriazole, thiadiazole, tetrazole, pyridine, pyridazine, pyrimidine, pyrazine, purine, pteridine, quinoline, isoquinoline, quinazoline, quinoxaline, cinnoline and triazine. A heteroaryl group may be substituted or unsubstituted.

As used herein, “heterocyclyl” or “heteroalicyclyl” refers to three-, four-, five-, six-, seven-, eight-, nine-, ten-, up to 18-membered monocyclic, bicyclic and tricyclic ring system wherein carbon atoms together with from 1 to 5 heteroatoms constitute said ring system. A heterocycle may optionally contain one or more unsaturated bonds situated in such a way, however, that a fully delocalized pi-electron system does not occur throughout all the rings. The heteroatom(s) is an element other than carbon including, but not limited to, oxygen, sulfur and nitrogen. A heterocycle may further contain one or more carbonyl or thiocarbonyl functionalities, so as to make the definition include oxo-systems and thio-systems such as lactams, lactones, cyclic imides, cyclic thioimides and cyclic carbamates. When composed of two or more rings, the rings may be joined together in a fused, bridged or spiro fashion. As used herein, the term “fused” refers to two rings which have two atoms and one bond in common. As used herein, the term “bridged heterocyclyl” or “bridged heteroalicyclyl” refers to compounds wherein the heterocyclyl or heteroalicyclyl contains a linkage of one or more atoms connecting non-adjacent atoms. As used herein, the term “spiro” refers to two rings which have one atom in common and the two rings are not linked by a bridge. Heterocyclyl and heteroalicyclyl groups can contain 3 to 30 atoms in the ring(s), 3 to 20 atoms in the ring(s), 3 to 10 atoms in the ring(s), 3 to 8 atoms in the ring(s) or 3 to 6 atoms in the ring(s). For example, five carbon atoms and one heteroatom; four carbon atoms and two heteroatoms; three carbon atoms and three heteroatoms; four carbon atoms and one heteroatom; three carbon atoms and two heteroatoms; two carbon atoms and three heteroatoms; one carbon atom and four heteroatoms; three carbon atoms and one heteroatom; or two carbon atoms and one heteroatom. Additionally, any nitrogens in a heteroalicyclic may be quaternized. Heterocyclyl or heteroalicyclic groups may be unsubstituted or substituted. Examples of such “heterocyclyl” or “heteroalicyclyl” groups include but are not limited to, 1,3-dioxin, 1,3-dioxane, 1,4-dioxane, 1,2-dioxolane, 1,3-dioxolane, 1,4-dioxolane, 1,3-oxathiane, 1,4-oxathiin, 1,3-oxathiolane, 1,3-dithiole, 1,3-dithiolane, 1,4-oxathiane, tetrahydro-1,4-thiazine, 2H-1,2-oxazine, maleimide, succinimide, barbituric acid, thiobarbituric acid, dioxopiperazine, hydantoin, dihydrouracil, trioxane, hexahydro-1,3,5-triazine, imidazoline, imidazolidine, isoxazoline, isoxazolidine, oxazoline, oxazolidine, oxazolidinone, thiazoline, thiazolidine, morpholine, oxirane, piperidine N-Oxide, piperidine, piperazine, pyrrolidine, azepane, pyrrolidone, pyrrolidione, 4-piperidone, pyrazoline, pyrazolidine, 2-oxopyrrolidine, tetrahydropyran, 4H-pyran, tetrahydrothiopyran, thiamorpholine, thiamorpholine sulfoxide, thiamorpholine sulfone and their benzo-fused analogs (e.g., benzimidazolidinone, tetrahydroquinoline and/or 3,4-methylenedioxyphenyl). Examples of spiro heterocyclyl groups include 2-azaspiro[3.3]heptane, 2-oxaspiro[3.3]heptane, 2-oxa-6-azaspiro[3.3]heptane, 2,6-diazaspiro[3.3]heptane, 2-oxaspiro[3.4]octane and 2-azaspiro[3.4]octane.

As used herein, “aralkyl” and “aryl(alkyl)” refer to an aryl group connected, as a substituent, via a lower alkylene group. The lower alkylene and aryl group of an aralkyl may be substituted or unsubstituted. Examples include but are not limited to benzyl, 2-phenylalkyl, 3-phenylalkyl and naphthylalkyl.

As used herein, “cycloalkyl(alkyl)” refer to an cycloalkyl group connected, as a substituent, via a lower alkylene group. The lower alkylene and cycloalkyl group of a cycloalkyl(alkyl) may be substituted or unsubstituted.

As used herein, “heteroaralkyl” and “heteroaryl(alkyl)” refer to a heteroaryl group connected, as a substituent, via a lower alkylene group. The lower alkylene and heteroaryl group of heteroaralkyl may be substituted or unsubstituted. Examples include but are not limited to 2-thienylalkyl, 3-thienylalkyl, furylalkyl, thienylalkyl, pyrrolylalkyl, pyridylalkyl, isoxazolylalkyl and imidazolylalkyl and their benzo-fused analogs.

A “heteroalicyclyl(alkyl)” and “heterocyclyl(alkyl)” refer to a heterocyclic or a heteroalicyclic group connected, as a substituent, via a lower alkylene group. The lower alkylene and heterocyclyl of a (heteroalicyclyl)alkyl may be substituted or unsubstituted. Examples include but are not limited tetrahydro-2H-pyran-4-yl(methyl), piperidin-4-yl(ethyl), piperidin-4-yl(propyl), tetrahydro-2H-thiopyran-4-yl(methyl) and 1,3-thiazinan-4-yl(methyl).

As used herein, the term “hydroxy” refers to a —OH group.

As used herein, “alkoxy” refers to the Formula —OR wherein R is an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl) is defined herein. A non-limiting list of alkoxys are methoxy, ethoxy, n-propoxy, 1-methylethoxy (isopropoxy), n-butoxy, iso-butoxy, sec-butoxy, tert-butoxy, phenoxy and benzoxy. An alkoxy may be substituted or unsubstituted.

The term “halogen atom” or “halogen” (e.g., —X^{H}) as used herein, means any one of the radio-stable atoms of column 7 of the Periodic Table of the Elements, such as, fluorine (—F), chlorine (—Cl), bromine (—Br), and iodine (—I).

As used herein, “haloalkyl” refers to an alkyl group in which one or more of the hydrogen atoms (or all) are replaced by a halogen (e.g., mono-haloalkyl, di-haloalkyl, tri-haloalkyl, polyhaloalkyl, and perhaloalkyl). The haloalkyl moiety may be branched or straight chain. Such groups include but are not limited to, chloromethyl, fluoromethyl, difluoromethyl, trifluoromethyl, 1-chloro-2-fluoromethyl, 2-fluoroisobutyl and pentafluoroethyl. Examples of haloalkyl groups include, but are not limited to, —CF₃, —CHF₂, —CH₂F, —CH₂CF₃, —CH₂CHF₂, —CH₂CH₂F, —CH₂CH₂Cl, —CH₂CF₂CF₃, —CF₂CF₂CF₃; —CF₂—CF₂—CF₂—CF₃; and other groups that in light of the ordinary skill in the art and the teachings provided herein, would be considered equivalent to any one of the foregoing examples (including fluoroalkyls). The haloalkyl may be a medium sized or lower haloalkyl. A haloalkyl may be represented by —(C(X^{H})₂)ₘ—X^{H}, where “m” is any integer between 1 and 20. A haloalkyl may be substituted or unsubstituted.

As used herein, “fluoroalkyl” refers to an haloalkyl group (or alkyl group) in which one or more of the hydrogen atoms are replaced by a fluorine (e.g., mono-fluoroalkyl, di-fluoroalkyl, tri-fluoroalkyl, polyfluoroalkyl, and perfluoroalkyl). Such groups include but are not limited to, fluoromethyl, difluoromethyl, trifluoromethyl, 2-fluoroisobutyl and pentafluoroethyl. Examples of haloalkyl groups include, but are not limited to, —CF₃, —CHF₂, —CH₂F, —CH₂CF₃, —CH₂CHF₂, —CH₂CH₂F, —CH₂CH₂Cl, —CH₂CF₂CF₃, —CF₂CF₂CF₃; —CF₂—CF₂—CF₂—CF₃; —CF₂—CF₂—CF₂—CF₂—CF₃; —CF₂—CF₂—CF₂—CF₂—CF₂—CF₃; —CF₂—CF₂—CF₂—CF₂—CF₂—CF₂—CF₃; —CF₂—CF₂—CF₂—CF₂—CF₂—CF₂—CF₂—CF₃; —CF₂—CF₂—CF₂—CF₂—CF₂—CF₂—CF₂—CF₂—CF₃; —CF₂—CF₂—CF₂—CF₂—CF₂—CF₂—CF₂—CF₂—CF₂—CF₃; —CF₂—CF₂—CF₂—CF₂—CF₂—CF₂—CF₂—CF₂—CF₂—CF₂—CF₃; —CF₂—CF₂—CF₂—CF₂—CF₂—CF₂—CF₂—CF₂—CF₂—CF₂—CF₂—CF₃; —CF₂—CF₂—CF₂—CF₂—CF₂—CF₂—CF₂—CF₂—CF₂—CF₂—CF₂—CF₂—CF₃; and other groups that in light of the ordinary skill in the art and the teachings provided herein, would be considered equivalent to any one of the foregoing examples. A fluoroalkyl may be a medium sized or lower fluoroalkyl. A fluoroalkyl may be represented by —(C(X^{H})₂)ₘ—X^{H}, where X^{H} is —F and “m” is any integer between 1 and 20. A fluoroalkyl may be a C₄ to C₁₀ fluoroalkyl, a C₆ to C₁₂ fluoroalkyl, a C₈ to C₁₄ fluoroalkyl, a C₁ to C₁₅ fluoroalkyl, a C₆ to C₂₀ fluoroalkyl, or the like.

As used herein, “haloalkoxy” refers to an alkoxy group in which one or more of the hydrogen atoms are replaced by a halogen (e.g., mono-haloalkoxy, di-haloalkoxy and tri-haloalkoxy). Such groups include but are not limited to, chloromethoxy, fluoromethoxy, difluoromethoxy, trifluoromethoxy, 1-chloro-2-fluoromethoxy and 2-fluoroisobutoxy. The haloalkoxy may be a medium sized or lower haloalkoxy. A haloalkoxy may be represented by —O—(C(X^{H})₂)ₙ—X^{H}, where “n” is any integer between 1 and 20. A haloalkoxy may be substituted or unsubstituted.

The terms “amino” and “unsubstituted amino” as used herein refer to a —NH₂ group.

A “mono-substituted amine” group refers to a “—NHR_{A}” group in which R_{A} can be an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein. The R_{A} may be substituted or unsubstituted. A mono-substituted amine group can include, for example, a mono-alkylamine group, a mono-C₁-C₆ alkylamine group, a mono-arylamine group, a mono-C₆-C₁₀ arylamine group and the like. Examples of mono-substituted amine groups include, but are not limited to, —NH(methyl), —NH(phenyl) and the like.

A “di-substituted amine” group refers to a “—NRAR_{B}” group in which R_{A} and R_{B} can be independently an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein. R_{A} and R_{B} can independently be substituted or unsubstituted. A di-substituted amine group can include, for example, a di-alkylamine group, a di-C₁-C₆ alkylamine group, a di-arylamine group, a di-C₆-C₁₀ arylamine group and the like. Examples of di-substituted amine groups include, but are not limited to, —N(methyl)₂, —N(phenyl)(methyl), —N(ethyl)(methyl) and the like.

As used herein, “mono-substituted amine(alkyl)” group refers to a mono-substituted amine as provided herein connected, as a substituent, via a lower alkylene group. A mono-substituted amine(alkyl) may be substituted or unsubstituted. A mono-substituted amine(alkyl) group can include, for example, a mono-alkylamine(alkyl) group, a mono-C₁-C₆ alkylamine(C₁-C₆ alkyl) group, a mono-arylamine(alkyl group), a mono-C₆-C₁₀ arylamine(C₁-C₆ alkyl) group and the like. Examples of mono-substituted amine(alkyl) groups include, but are not limited to, —CH₂NH(methyl), —CH₂NH(phenyl), —CH₂CH₂NH(methyl), —CH₂CH₂NH(phenyl) and the like.

As used herein, “di-substituted amine(alkyl)” group refers to a di-substituted amine as provided herein connected, as a substituent, via a lower alkylene group. A di-substituted amine(alkyl) may be substituted or unsubstituted. A di-substituted amine(alkyl) group can include, for example, a dialkylamine(alkyl) group, a di-C₁-C₆ alkylamine(C₁-C₆ alkyl) group, a di-arylamine(alkyl) group, a di-C₆-C₁₀ arylamine(C₁-C₆ alkyl) group and the like. Examples of di-substituted amine(alkyl)groups include, but are not limited to, —CH₂N(methyl)₂, —CH₂N(phenyl)(methyl), —CH₂N(ethyl)(methyl), —CH₂CH₂N(methyl)₂, —CH₂CH₂N(phenyl)(methyl), —NCH₂CH₂(ethyl)(methyl) and the like.

As used herein, the term “diamino-” denotes an a “—N(R_{A})R_{B}—N(R_{C})(R_{D})” group in which R_{A}, R_{C}, and R_{D} can be independently a hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein, and wherein R_{B} connects the two “N” groups and can be (independently of R_{A}, R_{C}, and R_{D}) a substituted or unsubstituted alkylene group. R_{A}, R_{B}, R_{C}, and R_{D} can independently further be substituted or unsubstituted.

As used herein, the term “polyamino” denotes a “—(N(R_{A})R_{B}—)ₙ—N(R_{C})(R_{D})”. For illustration, the term polyamino can comprise —N(R_{A})alkyl-N(R_{A})alkyl-N(R_{A})alkyl-N(R_{A})alkyl-H. In several embodiments, the alkyl of the polyamino is as disclosed elsewhere herein. While this example has only 4 repeat units, the term “polyamino” may consist of 1, 2, 3, 4, 5, 6, 7, 8, 9, or 10 repeat units. R_{A}, R_{C}, and R_{D} can be independently a hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein, and wherein R_{B} connects the two “N” groups and can be (independently of R_{A}, R_{C}, and R_{D}) a substituted or unsubstituted alkylene group. R_{A}, R_{C}, and R_{D} can independently further be substituted or unsubstituted. As noted here, the polyamino comprises amine groups with intervening alkyl groups (where alkyl is as defined elsewhere herein).

As used herein, the term “diether-” denotes an a “—OR_{B}O—R_{A}” group in which R_{A} can be a hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein, and wherein R_{B} connects the two “O” groups and can be a substituted or unsubstituted alkylene group. R_{A} can independently further be substituted or unsubstituted.

As used herein, the term “polyether” denotes a repeating —(OR_{B}—)ₙOR_{A} group. For illustration, the term polyether can comprise —Oalkyl-Oalkyl-Oalkyl-Oalkyl-OR_{A}. In several embodiments, the alkyl of the polyether is as disclosed elsewhere herein. While this example has only 4 repeat units, the term “polyether” may consist of 1, 2, 3, 4, 5, 6, 7, 8, 9, or 10 repeat units. R_{A} can be a hydrogen, an alkyl, an alkenyl, an alkynyl, a cycloalkyl, a cycloalkenyl, aryl, heteroaryl, heterocyclyl, cycloalkyl(alkyl), aryl(alkyl), heteroaryl(alkyl) or heterocyclyl(alkyl), as defined herein. R_{B} can be a substituted or unsubstituted alkylene group. R_{A} can independently further be substituted or unsubstituted. As noted here, the polyether comprises ether groups with intervening alkyl groups (where alkyl is as defined elsewhere herein and can be optionally substituted).

Where the number of substituents is not specified (e.g. haloalkyl), there may be one or more substituents present (e.g., 1, 2, 3, 4, 5, 6, 7, or more). For example, “haloalkyl” may include one or more of the same or different halogens. As another example, “C₁-C₃ alkoxyphenyl” may include one or more of the same or different alkoxy groups containing one, two or three atoms.

Wherever a substituent is depicted as a di-radical (i.e., has two points of attachment to the rest of the molecule), it is to be understood that the substituent can be attached in any directional configuration unless otherwise indicated. Thus, for example, a substituent depicted as -AE- or

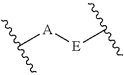

includes the substituent being oriented such that the “A” is attached at the leftmost attachment point of the molecule as well as the case in which “A” is attached at the rightmost attachment point of the molecule.

As noted in the definition for alkylene, it also is to be understood that certain radical naming conventions can include either a mono-radical or a di-radical, depending on the context. For example, where a substituent requires two points of attachment to the rest of the molecule, it is understood that the substituent is a di-radical. For example, a substituent identified as alkyl that requires two points of attachment includes di-radicals such as —CH₂—, —CH₂CH₂—, —CH₂CH(CH₃)CH₂—, and the like. Other examples a substituent may require two points of attachment include alkoxy, aryl, heteroaryl, carbocyclyl, heterocyclyl, etc.

As used herein, a radical indicates species with a single, unpaired electron such that the species containing the radical can be covalently bonded to another species. Hence, in this context, a radical is not necessarily a free radical. Rather, a radical indicates a specific portion of a larger molecule. The term “radical” can be used interchangeably with the term “group.”

When referring to a quantity or amount, the terms “or ranges including and/or spanning the aforementioned values” (and variations thereof) is meant to include any range that includes or spans the aforementioned values. For example, when the contact angle is expressed as “80°, 90°, 100°, 110°, or ranges including and/or spanning the aforementioned values,” this includes the particular contact angle provided (e.g., a contact angle equal to any one of 80°, 90°, 100°, or 110°) or contact angle ranges spanning the aforementioned values (e.g., from 80° to 110°, 80° to 100°, 80° to 90°, 90° to 110°, 90° to 100°, and 100° to 20%).

As used herein, a “natural diamond” refers to diamond that has not been chemically modified. A natural diamond may include a diamond that has been cut and shaped.

As used herein, a “raw diamond” is a natural diamond prior to plasma treatment and/or silanization.

Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “includes” should be interpreted as “includes but is not limited to;” the term “example” is used to provide exemplary instances of the item in discussion, not an exhaustive or limiting list thereof; and use of terms like “preferably,” “preferred,” “desired,” or “desirable,” and words of similar meaning should not be understood as implying that certain features are critical, essential, or even important to the structure or function of the invention, but instead as merely intended to highlight alternative or additional features that may or may not be utilized in a particular embodiment of the invention. In addition, the term “comprising” is to be interpreted synonymously with the phrases “having at least” or “including at least”. When used in the context of a process, the term “comprising” means that the process includes at least the recited steps, but may include additional steps. When used in the context of a compound, composition or device, the term “comprising” means that the compound, composition or device includes at least the recited features or components, but may also include additional features or components. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

Additionally, the phrase “consisting essentially of” will be understood to include those elements specifically recited and those additional elements that do not materially affect the basic and novel characteristics of the claimed technology. The phrase “consisting of” excludes any element not specified.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

The section headings used herein are for organizational purposes only and are not to be construed as limiting the subject matter described. Features disclosed under one heading (such as an antifouling surface) can be used in combination with features disclosed under a different heading (a method of using an antifouling surface). Unless defined otherwise, all technical and scientific terms used herein have the same meaning as is commonly understood by one of ordinary skill in the art. It should be noted that the use of particular terminology when describing certain features or aspects of the disclosure should not be taken to imply that the terminology is being re-defined herein to be restricted to include any specific characteristics of the features or aspects of the disclosure with which that terminology is associated.

### INTRODUCTION

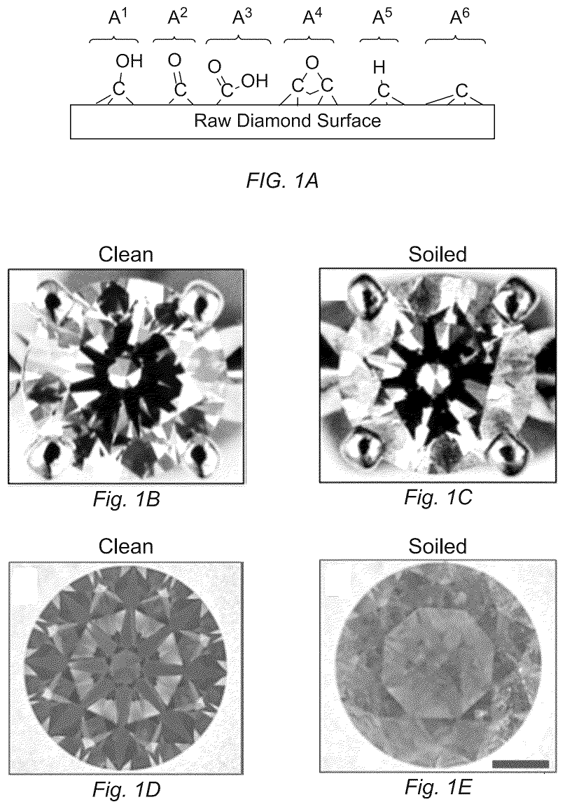

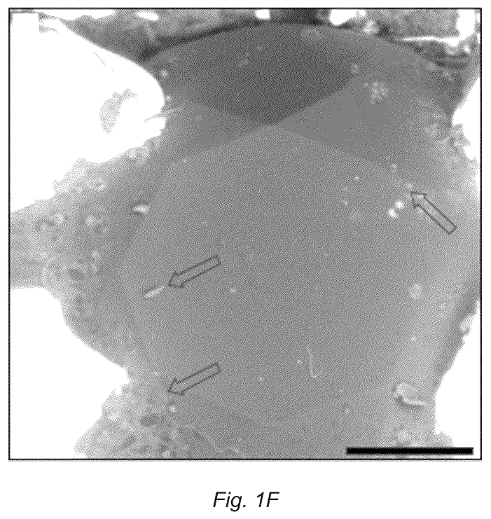

Diamond is a carbon crystal where carbon atoms are arranged in a regular lattice. In a diamond, the carbon atoms are arranged tetrahedrally. Each carbon atom is attached to four other carbon atoms 1.544×10⁻¹⁰ meter (1.544 angstroms (Å)) away. Three adjacent carbons make create a bond angle of 109.5°. The diamond lattice is a strong, rigid three-dimensional structure that results in a large network of atoms. While internal portions of a diamond are substantially pure carbon, at the surface, a natural cut diamond that comprises C—H bonds, epoxide groups, carbonyl groups, carboxylic acid groups, and hydroxyl groups. A representation of a raw diamond surface is shown in FIG. 1A. Less than 10% of the surface carbon atoms are linked to an acidic and/or carbonyl group. A small percentage of the surface area of a diamond surface includes hydroxyl groups. As such, the surface of a diamond is hydrophobic.

Given the hydrophobicity of natural diamond, as jewelry diamonds are worn or stored, the hydrophobic carbon lattice of the diamond begins to attract grease and grime. Over time, grease and grime builds up and dulls the diamond's brilliance and fire. This build-up is shown in FIGS. 1B to 1F for diamonds. FIGS. 1B and 1D, respectively, show a photograph and an ASET image of a clean diamond. FIGS. 1C and 1E, respectively, show a photograph and an ASET images of a dirty diamond. As can be noted, FIGS. 1C and 1E have less shine and brilliance than the clean diamond of FIGS. 1B and 1D. FIG. 1F shows a representative SEM image of a fouled diamond that shows dirt and grime accumulated (see arrows). The scale bars indicate 2 mm and 200 μm. This dirt and grime build-up and/or fouling can significantly reduce the user's enjoyment of their jewelry.

As disclosed elsewhere herein, this build-up happens at least in part due to the surface of a diamond being intrinsically hydrophobic. As a hydrophobic surface, it attracts hydrophobic residues, such as, smudges (from fingerprints), oil, grease, and grime. Diamonds naturally attract grease (lipophilic), but repel water (hydrophobic). This is a reason why the fire and brilliance that attracts consumers to diamond jewelry is quickly lost after they leave the showroom. Upon the mere touch of a human finger, oils and lotions can be transferred to the clean crystal surface. Once the crystal is fouled by these chemicals, dirt, protein, or other debris can more easily bind nonspecifically to the crystal and thereby diminish its sparkling appeal. This buildup is evident by visual inspection as well as ASET analysis, and can be observed in SEM as shown in FIGS. 1B-1F.

There are two conventional remedies to clean the grease and grime build up from the diamonds. The first is professional and/or commercial. A jeweler can clean soiled stones using an ultrasonic cleaner and/or a cleaning solution containing non-polar solvents. After cleaning, the brilliance and shine of the diamonds is restored (e.g., they are showroom-new). However, grease and grime will begin to accumulate as soon as the user leaves the showroom, because the diamond is hydrophobic. The second remedy consists of home cleaning products. Many home cleaners exist and work with varying degrees of success. Most will not clean the diamonds enough to restore the showroom-new brilliance of the stones. Furthermore, current solutions are merely restorative, meaning that any improvement in brilliance begins to fade immediately.

Maintenance of the pristine optical properties of jewelry for everyday use is a major challenge. Cleaning requires repetitive, tedious labor with chemical solutions and special tools. Finished jewelry items (comprising jewelry gemstones) are often physically complex with many differently sized stones and confined spaces between the stones and settings. Continuous maintenance can be done at home by chemical soaking (>2×/week), combined with an abrasive, mechanical action, such as a soft toothbrush, to remove remaining dirt, especially hard-to-reach places like the back of the diamond, which tends to collect the most contamination. Alternatively, ultrasonic cleaners are used professionally and are marketed to home users. While such cleaners can more effectively remove accumulated dirt and grime on diamonds, they are too physically disruptive and can dislodge stones from their settings. Repeated ultrasonic cleaning of mounted stones can chip the girdles of diamonds that are set next to each other, resulting in irreversible damage to the end product. Many end consumers lose interest in maintenance and tolerate chronically soiled jewelry simply because there are not practical viable alternatives. Both of the described current cleaning methods are either passive or post-treatment, they remove the offending material after it is present so that neither prevents the immediate recontamination of the piece.

Several embodiments disclosed herein solve these or other problems by providing soil-resistant coatings and methods of making and using such soil-resistant coatings. In several embodiments, a soil-resistant coating prevents, delays, lowers the incidences of, and/or decreases the amount of oil, grime, or other material that adheres to a substrate (when comparing the coated substrate to an uncoated substrate). In several embodiments, the coating comprises, consists of, or consists essentially of a monolayer. In several embodiments, the monolayer is formed directly on a substrate (e.g., a diamond surface). In this way, an intermediate reaction layer (e.g., a layer that provides a reactive “handle” for a monolayer precursor molecule to bond with) is not needed and/or is completely absent. An intermediate layer may be a siloxane layer over a substrate (e.g., a layer of SiO₂ covering the substrate). In several embodiments, the coated substrate lacks an intermediate layer between the monolayer and the substrate. For example, in several embodiments, a monolayer precursor molecule is reacted directly and covalently with a reactive group of the substrate. As such, a reactive group of the monolayer precursor molecule bonds (e.g., silanizing group) to a reactive group of the substrate forming a portion of the monolayer.

Advantageously, it has been found that pretreating the substrate in a specified manner improves the quality of the substrate coating (priming it for reaction with a silanizing agent). In several embodiments, prior to monolayer formation on the substrate, the substrate is pretreated and/or primed to receive and/or bond with the monolayer precursor molecule. In several embodiments, pretreatment has been found to allow denser and/or more regular packing of the monolayer on the substrate. This denser packing improves soil resisting properties. In several embodiments, pretreatment of the substrate improves the soil-resistant coating's performance and durability (e.g., with regard to the longevity of soil-resistance and/or the ability to resist soiling in the first place).

In several embodiments, the pretreatment step includes a step of plasma treating the substrate. Plasma is a mixture of neutral atoms, atomic ions, electrons, molecular ions, and molecules present in excited and ground states. Plasma may be generated by subjecting a gas to electric current. In several embodiments, the pretreatment step is performed using oxygen plasma or hydrogen plasma (or both). Oxygen plasma refers to any plasma process where oxygen is used in a plasma chamber to generate plasma. Hydrogen plasma refers to any plasma process where hydrogen is used in a plasma chamber to generate plasma. It has been found that oxygen and/or hydrogen treatment provides a plasma cleansed reactive substrate that is capable of accepting a more densely packed monolayer (e.g., having more monolayer molecular units per unit area) and/or a more regular monolayer (e.g., having more regularity of soil-resistance per unit area). In several embodiments, the oxygen and/or hydrogen gas may be mixed with argon gas to provide the plasma. In several embodiments, argon is not required and/or is not used. In several embodiments, the plasma gas used for pretreatment comprises, consists of, or consists essentially of oxygen. In several embodiments, the plasma gas used for pretreatment comprises, consists of, or consists essentially of hydrogen. In several embodiments, the plasma gas used for pretreatment comprises, consists of, or consists essentially of oxygen and argon. In several embodiments, the plasma gas used for pretreatment comprises, consists of, or consists essentially of hydrogen and argon.

In several embodiments, the plasma treatment includes a single step (e.g., treatment with oxygen plasma or hydrogen plasma). In other embodiments, the plasma treatment includes a multi-step plasma exposure regimen. For example, the regimen may include first a treatment with oxygen plasma, followed by treatment with hydrogen plasma (as a second treatment step). Alternatively, the regimen may include first a treatment with hydrogen plasma, followed by treatment with oxygen plasma (as a second treatment step). In several embodiments, as disclosed elsewhere herein, plasma treatment using oxygen plasma followed by hydrogen plasma (in two different steps), allows especially dense packing of reactive oxygen species after annealing.

In several embodiments, pretreatment of a substrate (e.g., the step of preparing the substrate surface for reaction to the monolayer precursor molecule) involves an additional step after plasma treatment. For example, the plasma treatment of the substrate may provide a precursor substrate. In several embodiments, the plasma treated substrate (e.g., the precursor substrate) is annealed. In several embodiments, the annealing process converts additional surface functional groups on the substrate to reactive groups. In several embodiments, the plasma treated substrate is annealed with water. In several embodiments, annealing with water increases the relative ratio of hydroxyl groups and/or carboxylic acid groups on the substrate. In several embodiments, an annealing step is beneficial to achieve desired levels of anti-soiling for a substrate (e.g., a diamond). In some embodiments, the annealing step may be omitted.

It has now been found that the high symmetry crystal planes of diamond (e.g., (111), (110), and (100)) have different atomic structures that impact any coating or hydroxylation of the surface. Prior to the disclosure provided herein, these issues were not readily appreciated when attempting to coat diamonds. These interfaces are commonly presented from synthetic depositions of or preparations for diamond. The orientation of the C—H or C—O axes and the relative corrugation are different, and oxygen plasma alone may be insufficient to give both high contact angles and abrasion resistance. Further complicating matters, this issue is especially problematic for gemstones (e.g., diamonds). For instance, gemstones are cut irrespective of these planes. In several embodiments, the approaches disclosed herein provide reliable coverage and abrasion resistance by maximizing the number of hydroxyl species. In several embodiments, a two-step process may be used. In several embodiments, first, the diamond is treated with oxygen plasma or hydrogen plasma for cleaning and to increase number of C—Ox species and/or C—H species. In several embodiments, second, a water vapor anneal process is performed to convert all C—H bonds to C—OH. In several embodiments, a three-step process may be used. In several embodiments, first, the diamond is treated with oxygen plasma for cleaning and to increase number of C—Ox species. In several embodiments, second, the diamond is treated with hydrogen plasma for a long duration to break epoxides and maximize number of C—H bonds. In several embodiments, third, a water vapor anneal process is performed to convert all C—H bonds to C—OH. In several embodiments, additional treatment steps may be used.

As disclosed elsewhere herein, in several embodiments, the substrate may be a gemstone. In several embodiments, the process and monolayers disclosed herein are especially useful for diamond surfaces (in view of the solutions to the problems disclosed elsewhere herein). Thus, diamond surfaces are used throughout this disclosure as an exemplary embodiment (e.g., an exemplary substrate). Nonetheless, while several examples are discussed using diamond as a reference substrate, the techniques and chemistry described herein can be adapted to other gemstones (e.g., alexandrite, amethyst, aquamarine, citrine, diamond, emerald, garnet, jade, lapis lazuli, moonstone, morganite, onyx, opal, paraiba, pearls, peridot, rubellite, ruby, sapphire, spinel, tanzanite, topaz, tourmaline, turquoise, and zircon), other crystalline materials (e.g. SiC, synthetic diamond, CVD diamond wafer, etc.), other carbonaceous materials (e.g. carbide-derived carbon, carbonaceous aerogel, nanocrystalline diamond, graphitic carbon containing matrices, polymer substrates, etc.), vitrified amorphous surfaces (e.g. diverse glasses, including crystal glass), polymers (e.g., polycarbonate glasses lens and sunglass lens), crystal glass, and the like.

The techniques and monolayer precursor molecules disclosed herein are especially useful for substrates where optical properties are essential and must be maintained in pristine condition (during use and/or through a coating process). The coatings disclosed herein are especially suited to maintain or even improve the optical quality of the substrates they are used to modify. The techniques and coatings disclosed herein may be used to render diamond jewelry, glasses lenses, sunglass lenses, watch faces, spyglasses, gun scopes, periscopes, and the like soil-resistant (and/or fog resistant). In several embodiments, the substrate is configured for use as a lens (e.g., for viewing through). In several embodiments, the substrate is polymer or glass. In several embodiments, the substrate is a magnifying lens (e.g., of a telescope, binoculars, a scope, etc.). In several embodiments, the polymer is a polycarbonate (e.g., a polycarbonate sunglass lens or glasses lens). In several embodiments, the substrate is a glass (e.g., a glass sunglass lens or glass glasses lens). In several embodiments, the substrate is a crystal glass.

Surface-Functionalized Substrates and Their Methods of Manufacture and Use

As disclosed elsewhere herein, several embodiments pertain to soil-resistant coatings on substrates. In several embodiments, the coating (e.g., monolayer coating) changes the natural surface chemistry of the substrate surface (e.g., diamond surface) and/or the physical properties of the substrate surface (e.g., diamond surface) to which the coating is bonded. As disclosed elsewhere herein, diamonds (and/or some other gemstones or substrates) are largely chemically inactive, making it difficult to coat them to prevent soiling. Until now, techniques to attach a physical coating directly to a diamond surface have been largely ineffective. For instance, the largely inert surface of a diamond may resist interaction with a reactive monolayer precursor molecule. As noted elsewhere herein, the diamond surface has an abundance of groups that are not reactive to coating materials (e.g., silanizing groups). Thus, during coating, bare spots and/or irregular surfaces may be left, frustrating the purpose of coating the diamond in the first place. This problem associated with diamond coatings (and coatings for other substrates) or others are addressed herein.

Additionally, this lack of sufficient and/or adequate reactivity is also an issue for diamonds that have been plasma treated. While plasma treating improves coating efficiency on diamonds (and some other substrates), plasma treating itself is not to a sufficient degree to avoid bare spots and/or irregularities within the coating. Thus, the diamond can still attract dirt and grime readily. In some embodiments disclosed herein, the surface of a diamond (or other gemstone or substrate) is subject to a two-or-more step process to prepare and/or change the surface, thereby conferring reactivity to the surface. For instance, a diamond (or other substrate) may be plasma treated to increase the amount of reactive and/or nucleophilic groups on the surface of the diamond (or other substrate). Thereafter, the substrate surface is annealed to further increase the amount of reactive species on the surface (e.g., reactive oxygen species).

As disclosed elsewhere herein, the plasma treatment process may be performed using oxygen, hydrogen, or both (in different treatment steps). Argon may also be used in combination with either oxygen or hydrogen. Because the molecular speed of hydrogen gas is low (due to its low mass), in several embodiments, argon gas is used simultaneously with hydrogen. Alternatively, argon maybe used to purge the plasma chamber to ensure hydrogen gas is pumped out of the chamber after plasma treatment of an article within the chamber (e.g., a diamond, lens, etc.). In several embodiments, different cycles of plasma gas may be used during plasma treatment. For example, in several embodiments, plasma treatment may include exposure of the article to oxygen plasma, followed by hydrogen plasma. In other embodiments, plasma treatment may include exposure of the article to hydrogen plasma, followed by oxygen plasma. In several embodiments, plasma treatment may include exposure of the article may include exposure to high pressure oxygen plasma followed, by low pressure oxygen plasma, followed by low pressure hydrogen plasma. In several embodiments, plasma treatment may include exposure of the article to oxygen plasma, followed by hydrogen plasma. Other combinations are possible. In several embodiments, plasma treatment may include exposure of the article to multiple hydrogen plasma treatments, multiple oxygen plasma treatments, or multiple hydrogen and oxygen plasma treatments (performed sequentially).

In several embodiments, during plasma treatment, an article to be treated is placed in a plasma treatment chamber. In several embodiments, a plasma gas (e.g., oxygen, hydrogen, combinations of the foregoing with argon, etc.) is fed into the plasma chamber. In several embodiments, the plasma generator generates plasma by exposing the plasma gas to electrical power of equal to or greater than about: 50 W, 100 W, 150 W, 200 W, or ranges including and/or spanning the aforementioned values. In several embodiments, where different plasma treatment steps are performed (e.g., a first and second plasma treatment step using oxygen and hydrogen, respectively), different electrical power levels may be used. For example, the first plasma treatment may be performed at one power, and the second at a second higher power. In several embodiments, the electrical power for the first treatment is equal to or less than about: 50 W, 100 W, 150 W, or ranges including and/or spanning the aforementioned values. In several embodiments, the electrical power for the second treatment is equal to or less than about: 100 W, 150 W, 200 W, or ranges including and/or spanning the aforementioned values.

In several embodiments, the flow rate of the plasma gas may be controlled. In several embodiments, the flow rate of gas is equal to or less than about: 1 standard cubic centimeters per minute (sccm), 5 sccm, 10 sccm, 15 sccm, 20 sccm, 25 sccm, 30 sccm, 50 sccm, 75 sccm, 100 sccm, or ranges including and/or spanning the aforementioned values. In several embodiments, where different plasma treatment steps are performed (e.g., a first and second plasma treatment step using oxygen and hydrogen, respectively), different flow rates may be used. For example, the first plasma treatment may be performed at one flow rate and the second at a second flow rate. In several embodiments, the first flow rate is slower than the second. In other embodiments, the first flow rate is faster than the second. In several embodiments, the first flow rate of gas is equal to or less than about: 1 standard cubic centimeters per minute, 5 sccm, 10 sccm, 15 sccm, 20 sccm, 25 sccm, 30 sccm, 50 sccm, 75 sccm, 100 sccm, or ranges including and/or spanning the aforementioned values. In several embodiments, the second flow rate of gas is equal to or less than about: 1 standard cubic centimeters per minute (sccm), 5 sccm, 10 sccm, 15 sccm, 20 sccm, 25 sccm, 30 sccm, 50 sccm, 75 sccm, 100 sccm, or ranges including and/or spanning the aforementioned values.

In several embodiments, the gas pressure used during plasma treatment can be higher or lower depending on the desired result. In several embodiments, higher gas pressures may be used when faster plasma treatment times are desired. In several embodiments, the gas pressure during plasma treatment is equal to or less than about: 100 mtorr, 200 mtorr, 300 mtorr, 320 mtorr, 350 mtorr, 400 mtorr, 600 mtorr, or ranges including and/or spanning the aforementioned values. In several embodiments, where different plasma treatment steps are performed (e.g., a first and second plasma treatment step using oxygen and hydrogen, respectively), different pressure levels may be used. For example, the first plasma treatment may be performed at one pressure, and the second at a second pressure.

In several embodiments, the duration of plasma treatment can be adjusted depending on the article being treated. In several embodiments, the duration of plasma treatment is equal to or less than about: 2 minutes, 10 minutes, 20 minutes, 30 minutes, 45 minutes, 1 hour, or ranges including and/or spanning the aforementioned values. In several embodiments, where different plasma treatment steps are performed (e.g., a first and second plasma treatment step using oxygen and hydrogen, respectively), different exposure times may be used. For example, the first plasma treatment may be performed for one period of time, and the second for a second period of time. In several embodiments, the first period of time is shorter than the second. In other embodiments, the first period of time is longer than the second. In several embodiments, the duration of plasma treatment for the first period of time is equal to or less than about: 2 minutes, 10 minutes, 20 minutes, 30 minutes, or ranges including and/or spanning the aforementioned values. In several embodiments, the duration of plasma treatment for the second period of time is equal to or less than about: 20 minutes, 30 minutes, 45 minutes, 1 hour, or ranges including and/or spanning the aforementioned values.

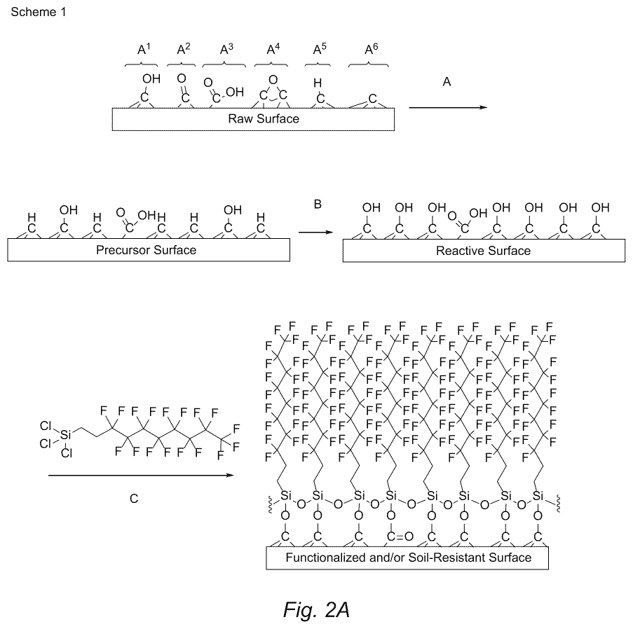

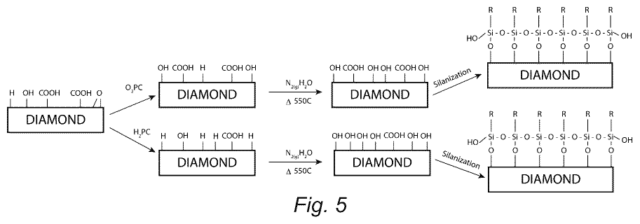

In several embodiments, as shown in FIGS. 2A, 2B, and 5, the surface of a raw substrate or raw diamond comprises hydroxyl groups, carbonyl groups, carboxylic acid groups, epoxide groups, C—H groups, and C—C groups. These hydroxyl groups, carbonyl groups, carboxylic acid groups, epoxide groups, C—H groups, and C—C groups are represented using a diamond surface, Surface (I-r), using groups A¹, A², A³, A⁴, A⁵, and A⁶, respectively:

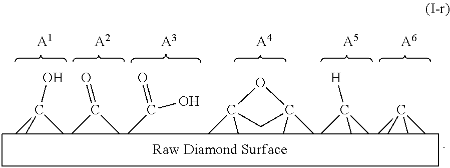

In several embodiments, the precursor substrate surface (e.g., the precursor diamond surface) comprises additional reactive oxygen species relative to the raw substrate surface (e.g., the raw diamond surface). For instance, the ratio of reactive oxygen species, A¹ and/or A³ (hydroxyl groups and/or carboxylic acid groups, respectively), relative to a total number of surface groups, A¹ to A⁶, may be increased after plasma treatment. In several embodiments, the ratio of reactive oxygen species is quantitatively calculated as (A¹)/(A¹+A²+A³+A⁴+A⁵+A⁶), as (A³)/(A¹+A²+A³+A⁴+A⁵+A⁶), or as (A¹+A³)/(A¹+A²+A³+A⁴+A⁵+A⁶). The (A¹)/(A¹+A²+A³+A⁴+A⁵+A⁶) may be abbreviated using the following term Ratio^{Precursor(1)} (where the substrate surface and ratio being indicated is provided as a superscript on “Ratio”). Similarly, the ratio of A³ groups to total groups on the precursor surface may be expressed as Ratio^{Precursor(3)}. Likewise, the ratio of A¹ and A³ groups to total groups on the precursor surface may be expressed as Ratio^{Precursor(1,3)}. This same naming convention may be used for the raw substrate by replacing the term “Precursor” in the superscript with the term “Raw” (e.g., Ratio^{Raw(1)}, Ratio^{Raw(1)}, Ratio^{Raw(1)}). In several embodiments, this ratio is quantitively determined (e.g., using spectroscopy, such as XPS (X-ray photoelectron spectroscopy)). In several embodiments, this ratio is qualitatively calculated (e.g., using FT-IR (Fourier transform infrared), FTIR ATR (attenuated total internal reflectance) spectroscopy, or other spectroscopic techniques). For example, the height and/or area of representative peaks may be compared (e.g., indicative C—OH peaks, C═O peaks, C—O—C peaks, C—H peaks, etc.).

In several embodiments, the ratio of A¹ and/or A³ groups relative to a total number of surface groups A¹ to A⁶ for the precursor surface (e.g., precursor diamond surface) is higher than the ratio of A¹ and/or A³ groups relative to a total number of surface groups A¹ to A⁶ for the raw substrate surface (e.g., raw diamond surface). For example, any one or more of the following may be true: Ratio^{Prrecursor(1)}>Ratio^{Raw(1)}, Ratio^{Precursor(3)}>Ratio^{Raw(3)}, Ratio^{Precursor(1,3)}>Ratio^{Raw(1,3)}. In several embodiments, after conversion to the precursor surface (e.g., the precursor diamond surface), the amount of reactive oxygen species (e.g., A¹ groups, A³ groups, and/or both) of the surface is increased by equal to or at least about: 10%, 25%, 50%, 100%, 150%, 200%, 300%, or ranges including and/or spanning the aforementioned values.

In several embodiments, the increase in the ratio of reactive groups increases the hydrophilicity of the precursor surface relative to the raw surface. In several embodiments, a contact angle for water on the raw surface is equal to or at least about: 30°, 40°, 50°, 60°, 70°, 80°, 90°, 100°, or ranges including and/or spanning the aforementioned values. In several embodiments, a contact angle for water on the precursor surface is equal to or at least about: 25°, 30°, 40°, 50°, 60°, 70°, 80°, 90°, or ranges including and/or spanning the aforementioned values. In several embodiments, after conversion to the precursor surface, the water contact angle of the substrate surface is lowered (relative to the raw surface) by equal to or at least about: 2.5%, 5%, 10%, 15%, 20%, 50%, 75%, or ranges including and/or spanning the aforementioned values.

In several embodiments, the increase in the ratio of reactive groups increases the hydrophilicity of the precursor diamond surface relative to the raw diamond surface. In several embodiments, a contact angle for water on the raw diamond surface is equal to or at least about: 40°, 50°, 60°, 70°, 80°, 90°, or ranges including and/or spanning the aforementioned values. In several embodiments, a contact angle for water on the precursor diamond surface is equal to or at least about: 25°, 30°, 40°, 50°, 60°, 70°, 80°, or ranges including and/or spanning the aforementioned values. In several embodiments, after conversion to the precursor diamond surface, the water contact angle of the diamond surface (e.g., the raw diamond surface) is lowered by equal to or at least about: 2.5%, 5%, 10%, 15%, 20%, 50%, 75%, or ranges including and/or spanning the aforementioned values.

In several embodiments, the plasma treated article (e.g., diamond or some other article) is thereafter annealed to provide additional reactive groups on the surface. In several embodiments, as shown in FIGS. 2A and 2B, plasma treatment of a substrate generates additional reactive species on the substrate (FIG. 2A) and the diamond (FIG. 2B) (see also, FIG. 5). As shown in FIGS. 2A and 2B, the plasma treatment in Step A provides a Precursor Surface and a Precursor Diamond Surface, respectively. In several embodiments, the reactive groups of the Precursor Surface and Precursor Diamond Surface include —OH groups and carboxylic acid groups (e.g., reactive oxygen species) at the surface of the substrate or diamond (or other substrate). In several embodiments, these reactive oxygen groups are nucleophilic. By annealing, additional and more regularly distributed reactive oxygen species are provided on the substrate surface (as shown in FIGS. 2A and 2B as the Reactive Surface and Reactive Diamond Surface, generated in Step B).

In several embodiments, the procedures disclosed herein, including the plasma treatment processes disclosed herein, increase the relative ratio of —OH species (A¹ groups) on the surface of the substrate. In several embodiments, this provides a more regular bonding surface with stronger bonding to the silanizing agent than surfaces where the ratio of —C(═O)OH is higher (though carboxylic acid groups (e.g., A³ groups) are still somewhat reactive to silanizing agents). In several embodiments, by increasing the ratio of hydroxyl species, longer lasting, more durable, and/or more soil-resistant surfaces are provided.

In several embodiments, as disclosed elsewhere herein, an annealing process is performed using water (e.g., water vapor). In several embodiments, annealing further increases the relative ratio of —OH species (A¹ groups) on the surface of the substrate. In several embodiments, water is provided in a carrier gas (e.g., nitrogen, argon, etc.) to anneal the surface of the substrate (e.g., diamond surface).

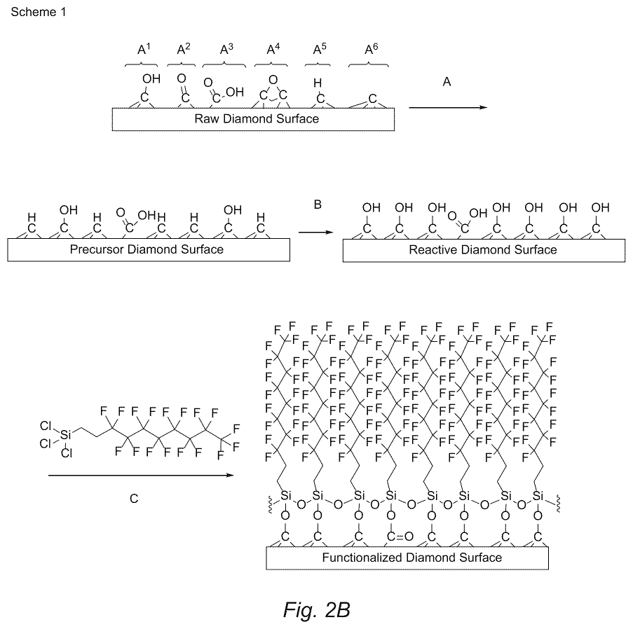

In several embodiments, the annealing process preformed using heat. In several embodiments, as shown in FIG. 3, the annealing process may comprise flowing an inert gas (e.g., nitrogen) through water to provide water vapor in the gas. In several embodiments, the annealing process is performed using heat by placing the substrate in heater (e.g., a furnace) as it is exposed to water vapor. In several embodiments, the annealing process is performed at a temperature equal to or at least about: 300° C., 400° C., 450° C., 500° C., 550° C., 600° C., or ranges including and/or spanning the aforementioned values.

In several embodiments, the reactive substrate surface (e.g., the reactive diamond surface) comprises additional reactive oxygen species relative to the precursor surface and/or the raw substrate surface (e.g., the precursor or raw diamond surface). For instance, the ratio of reactive oxygen species, A¹ and/or A³, relative to a total number of surface groups, A¹ to A⁶, may be increased after annealing. As above, the ratio of reactive oxygen species may be expressed as Ratio^{Reactive(1)}, Ratio^{Reactive(3)}, and/or Ratio^{Reactive(1,3)}. In several embodiments, this ratio is qualitatively calculated (e.g., using FT-IR, FTIR ATR, spectroscopy, or other spectroscopic techniques). For example, the height and/or area of representative peaks may be compared.

In several embodiments, the ratio of A¹ and/or A³ groups relative to a total number of surface groups A¹ to A⁶ for the reactive surface (e.g., reactive diamond surface) is higher than the ratio of A¹ and/or A³ groups relative to a total number of surface groups A¹ to A⁶ for the raw substrate surface (e.g., raw diamond surface). For example, any one or more of the following may be true: Ratio^{Reactive(1)}>Ratio^{Raw(1)}, Ratio^{Reactive(3)}>Ratio^{Raw(3)}, Ratio^{Reactive(1,3)}>Ratio^{Raw(1,3)}. In several embodiments, after conversion to the reactive surface (e.g., the reactive diamond surface), the amount of reactive oxygen species (e.g., A¹ groups, A³ groups, and/or both) of the surface relative to that of the raw surface (e.g., the raw diamond surface) is increased by equal to or at least about: 10%, 25%, 50%, 100%, 150%, 200%, 300%, 400%, or ranges including and/or spanning the aforementioned values.

In several embodiments, the ratio of A¹ and/or A³ groups relative to a total number of surface groups A¹ to A⁶ for the reactive surface (e.g., reactive diamond surface) is higher than the ratio of A¹ and/or A³ groups relative to a total number of surface groups A¹ to A⁶ for the precursor substrate surface (e.g., precursor diamond surface). For example, any one or more of the following may be true: Ratio^{Reactive(1)}>Ratio^{Precursor(1)}, Ratio^{Reactive(3)}>Ratio^{Precursor(3)}, Ratio^{Reactive(1,3)}>Ratio^{Precursor(1,3)}. In several embodiments, after conversion to the reactive surface (e.g., the reactive diamond surface), the amount of reactive oxygen species (e.g., A¹ and/or A³ groups) of the surface relative to that of the precursor surface (e.g., the precursor diamond surface) is increased by equal to or at least about: 10%, 25%, 50%, 100%, 150%, 200%, 300%, or ranges including and/or spanning the aforementioned values.

In several embodiments, the increase in the ratio of reactive groups increases the hydrophilicity of the reactive surface (e.g., reactive diamond surface) relative to the precursor surface (e.g., precursor diamond surface). In several embodiments, a contact angle for water on the precursor surface (e.g., precursor diamond surface) is equal to or at least about: 25°, 30°, 40°, 50°, 60°, 70°, 80°, or ranges including and/or spanning the aforementioned values. In several embodiments, a contact angle for water on the reactive surface (e.g., reactive diamond surface) is equal to or at least about: 5°, 10°, 20°, 30°, 40°, 50°, 60°, 70°, or ranges including and/or spanning the aforementioned values. In several embodiments, after conversion to the reactive surface (e.g., reactive diamond surface), the water contact angle of the substrate surface is lowered, relative to the precursor surface (e.g., precursor diamond surface), by equal to or at least about: 10%, 20%, 30%, 40%, 50%, 60%, 70%, 80%, 90%, 95%, 99%, or ranges including and/or spanning the aforementioned values.

In several embodiments, after pretreatment, nucleophilic groups on the surface of the substrate (e.g. diamond) can be functionalized. In several embodiments, the nucleophilic groups on the reactive surface of the substrate are functionalized using a silanizing group. The silanizing group is a monolayer precursor molecule. In several embodiments, the silanizing group may include halo-silane (e.g., Si(X^{H})₃—R, Si(X^{H})₂—R₂, Si(X^{H})—R₃, etc., where R is a tail), hydride-silane (e.g., SiH₃—R, SiH₂—R₂, SiH—R₃, etc., where R is a tail), or alkoxysilane (e.g., Si(—O-alkyl)₃-R, Si(—O-alkyl)₂-R₂, Si(—O-alkyl)-R₃, etc., where R is a tail). Such a functionalization is shown in Step C of FIGS. 2A and 2B. The functionalization is also shown in FIG. 5.

In several embodiments, by functionalizing the nucleophilic groups of the substrate using a silanizing group, the substrate (e.g., diamond, lens, etc.) becomes functionalized with a silane unit. In this way, a substrate (e.g., diamond, gemstone, lens, etc.) with an anti-fouling and/or soil resistant coating can be prepared. In several embodiments, the silane unit-coated substrate (e.g., diamond, lens, etc.) is adapted to repel grease and grime. In several embodiments, this modification results in a functionalized substrate (e.g., diamond, lens, etc.) that repels dirt and oil for longer periods and prevents and/or slows the soiling of the substrate surface (e.g., diamond, gemstone, glass, lens, or polycarbonate surface). In several embodiments, the functionalized substrate (e.g., diamond, lens, etc.) is hydrophobic (repels aqueous liquids, including water). In several embodiments, the coated surface of the diamond is amphiphobic (repels both oils and water). In several embodiments, a contact angle for canola oil or olive oil on the coated surface (e.g., coated diamond surface) is equal to or at least about: 45°, 50°, 60°, 70°, 80°, 90°, 100°, or ranges including and/or spanning the aforementioned values.

In several embodiments, as disclosed elsewhere herein, the anti-soiling and/or soil-resistant surface coating is covalently bonded to the substrate (e.g., diamond). In several embodiments, the anti-soiling surface coating comprises, consists of, or consists essentially of a monolayer. In several embodiments, the substrate surface and monolayer is represented by Surface (I):

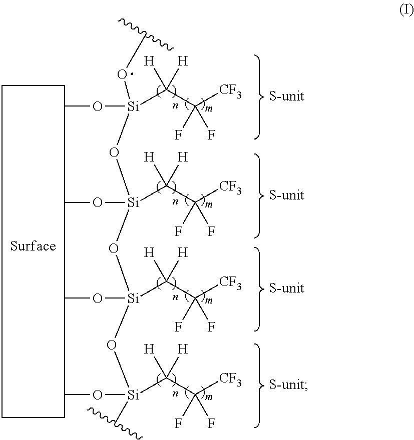

In several embodiments, n is an integer equal to or less than about: 0, 1, 2, 3, 4, 5, 6, 7, 8, or ranges including and/or spanning the aforementioned values. For example, in several embodiments, n is an integer ranging from 0 to 10, from 0 to 8, from 0 to 6, or from 0 to 4. To further illustrate, in several embodiments, n is an integer selected from 0, 1, 2, 3, or 4. In several embodiments, m is an integer equal to or less than about: 0, 1, 2, 3, 4, 5, 6, 7, 8, 9, 10, 11, 12, 15, 20, or ranges including and/or spanning the aforementioned values. For example, in several embodiments, m is an integer ranging from 1 to 15, from 1 to 20, from 6 to 8, from 6 to 10, or from 6 to 12. In several embodiments, m is equal to or greater than about: 6, 7, 8, 9, 10, 11, or 12. In several embodiments, n is 2. In several embodiments, m is between 6 and 12. In several embodiments, m is 8. In several embodiments, the “S-unit” is a silane unit. In several embodiments, a collection of S-units provide a monolayer. In several embodiments, the Surface is a substrate surface. In several embodiments, the surface is a diamond surface. In other embodiments, the Surface may be that of another gemstone. In several embodiments the Surface is glass, a polymer surface, etc. In several embodiments, the Surface is the surface of a watch face, is a glasses lens, a sunglass lens, or a magnifying lens.

It will be appreciated that Surface (I) provides a representative example showing that each Si atom may bond to an adjacent Si atom and the substrate to provide a monolayer spanning the surface. Instead of being covalently bonded to two adjacent Si atoms, certain Si atoms may have additional bonds to the substrate surface (e.g., through hydroxyl groups). Such an embodiment is shown below (and elsewhere herein in Surface (IV)). In several embodiments, a Si atom in the monolayer can have 1, 2, or 3 to the substrate itself (e.g., through a hydroxyl group). Thus, any of the following (Si-Attachment) arrangements is possible for any of the Surface representations provided herein. The “ [symbol] ” portions in the following structures indicate bonding through an —O— to an adjacent Si atom. For instance, Si-Attachment “A” is as shown in Surface (I). However, the S-units of Surface (I) (or any other surface disclosed herein, including, Surface (I-i), (II), (III), (IV), (IV-i)) can be replaced by Si-Attachment B, C, D, or E.

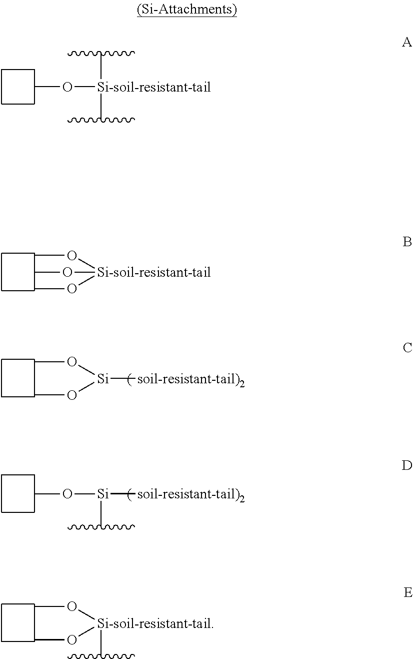

As disclosed elsewhere herein, in several embodiments, each “S-unit” represents a silane unit. In several embodiments, the silane unit comprises Si(CH₂)ₙ(CF₂)ₘCF₃. In several embodiments, each S-unit comprises a tail (e.g., a soil resistant tail). In several embodiments, the tail (e.g., a soil resistant tail) of the S-unit confers soil resistant properties on the surface (when combined with other S-units). In several embodiments, each nm² of the soil resistant surface (e.g., soil resistant diamond surface) comprises equal to or at least about: 1 S-unit, 2 S-unit, 3 S-unit, or ranges including and/or spanning the aforementioned values. In several embodiments, each nm² of the soil resistant surface (e.g., soil resistant diamond surface) comprises equal to or at least about: 1 tail, 2 tails, 3 tails, or ranges including and/or spanning the aforementioned values.

In several embodiments, the Surface (I) is further represented by Surface (I-i):

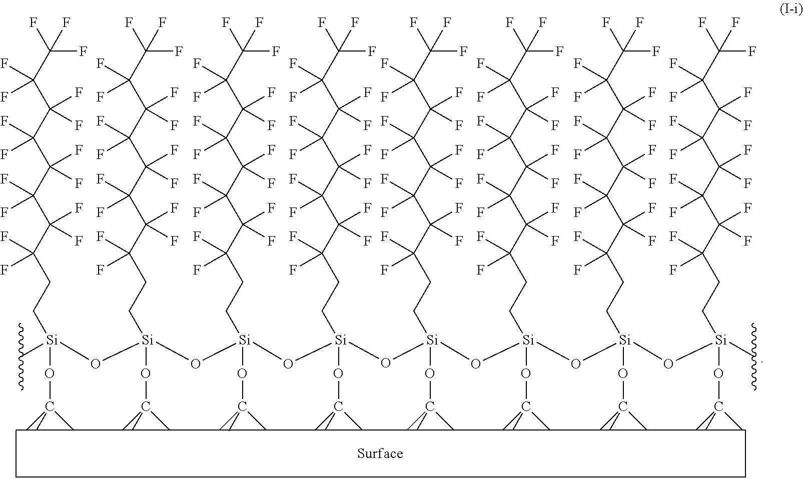

where n is 2 and m is 7. In several embodiments, definitions for like variables in different formulae (n for Formula (I) and Formula (II), etc.) maybe used to define that like variable for any other formula where the variable occurs. Thus, any definition of a variable for Formula (I) may be defined using that same variable for any one or more of Formula (I-i), (II), (III), and (IV), (or vice versa).

In several embodiments, the substrate surface and monolayer is represented by Surface (II):

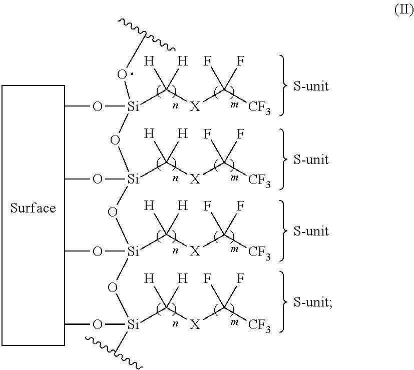

where variables are as disclosed elsewhere herein and X is —O—, —NH—, or —CF₂—. In several embodiments, n is an integer equal to or less than about: 0, 1, 2, 3, 4, 5, 6, 7, 8, or ranges including and/or spanning the aforementioned values. In several embodiments, m is an integer equal to or less than about: 0, 1, 2, 3, 4, 5, 6, 7, 8, 9, 10, 11, 12, 15, 20, 21, or ranges including and/or spanning the aforementioned values. In several embodiments, Surface (II) is represented by Surface (I) when X is —CF₂—.

In several embodiments, the substrate surface and monolayer is represented by Surface (III):

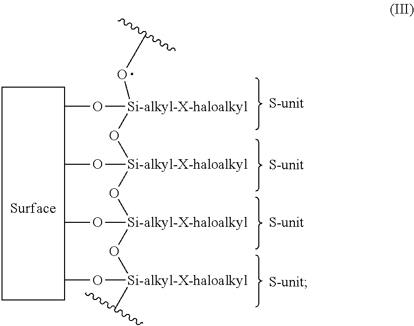

In several embodiments, alkyl is as disclosed elsewhere herein. In several embodiments, the alkyl in Formula (III) is optionally substituted C₁ to C₈ alkyl. In several embodiments, the alkyl in Formula (III) is optionally substituted C₁ to C₆ alkyl. In several embodiments, the alkyl in Formula (III) is optionally substituted C₁ to C₄ alkyl. In several embodiments, the alkyl in Formula (III) is optionally substituted C₁, C₂, C₃, C₄, C₅, C₆, C₇, C₈, C₉, or C₁₀ alkyl. In several embodiments, the alkyl in Formula (III) is branched. In several embodiments, the alkyl in Formula (III) is —(CH₂)ₙ—. In several embodiments, haloalkyl is as disclosed elsewhere herein. In several embodiments, the haloalkyl in Formula (III) is optionally substituted C₁ to C₂₀ haloalkyl. In several embodiments, the haloalkyl in Formula (III) is optionally substituted C₁ to C₁₂ haloalkyl. In several embodiments, the haloalkyl in Formula (III) is optionally substituted C₁ to C₆ haloalkyl. In several embodiments, the alkyl in Formula (III) is optionally substituted C₆ to C₁₂ haloalkyl. In several embodiments, the haloalkyl in Formula (III) is optionally substituted C₁, C₂, C₃, C₄, C₅, C₆, C₇, C₈, C₉, C₁₀, C₁₁, C₁₂, haloalkyl. In several embodiments, the haloalkyl in Formula (III) is branched. In several embodiments, the haloalkyl in Formula (III) is —(CF₂)ₘ—CF₃. In several embodiments, haloalkyl is fluoroalkyl. In several embodiments, haloalkyl is perfluoroalkyl. In several embodiments, X is —O—, —NH—, or —CF₂—. In several embodiments, n is an integer equal to or less than about: 0, 1, 2, 3, 4, 5, 6, 7, 8, or ranges including and/or spanning the aforementioned values. In several embodiments, m is an integer equal to or less than about: 0, 1, 2, 3, 4, 5, 6, 7, 8, 9, 10, 11, 12, 15, 20, 21, or ranges including and/or spanning the aforementioned values. In several embodiments, Surface (III) may be represented by Surface (I), (I-i), or (II). Alternatively, the Si bonding to the substrate surface may be represented by

In several embodiments, the substrate surface and monolayer is represented by Surface (IV):

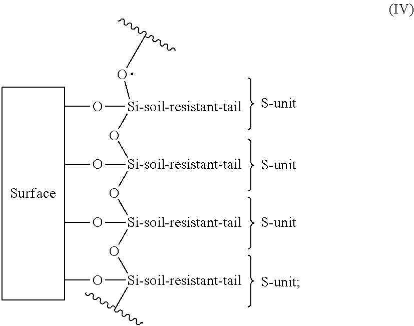

In several embodiments, Surface (IV) may be represented by any one of Surfaces (I), (II) or (III). For instance, in several embodiments, the “soil-resistant-tail” is represented by -alkyl-X-haloakyl. In several embodiments, the “soil-resistant-tail” is an optionally substituted alkyl. In several embodiments, the “soil-resistant-tail” is an optionally substituted haloalkyl. In several embodiments, the “soil-resistant-tail” is represented by -alkyl-haloakyl. In several embodiments, the “soil-resistant-tail” is represented by —(CH₂)ₙ—X—(CF₂)ₘ—CF₃. In several embodiments, the “soil-resistant-tail” is represented (or comprises) by —(CH₂)ₙ—(CF₂)ₘ—CF₃. In several embodiments, the “soil-resistant-tail” is a substituent selected from the group consisting of heptafluoroisopropoxypropyl, heptafluoroisopropoxypropyl-, bis(nonafluorohexyldimethylsiloxy)methyl-silylethyl-, tridecafluoro-2-(tridecafluorohexyl)decyl-, heneicocyl-1,1,2,2-tetrahydrodecyl-, (tridecafluoro-1,1,2,2-tetrahydrooctyl)-, (tridecafluoro-1,1,2,2-tetrahydrooctyl)-, (tridecafluoro-1,1,2,2-tetrahydrooctyl)methyl-, (tridecafluoro-1,1,2,2-tetrahydrooctyl)-, (tridecafluoro-1,1,2,2-tetrahydrooctyl)-, (tridecafluoro-1,1,2,2-tetrahydrooctyl)-, (heptadecafluoro-1,1,2,2-tetrahydrodecyl)-, (heptadecafluoro-1,1,2,2-tetrahydrodecyl)-, (heptadecafluoro-1,1,2,2-tetrahydrodecyl)-, (heptadecafluoro-1,1,2,2-tetrahydrodecyl)-, (heptadecafluoro-1,1,2,2-tetrahydrodecyl)-, and combinations of any of the foregoing.

In several embodiments, the substrate surface and monolayer is represented by Surface (IV-i):

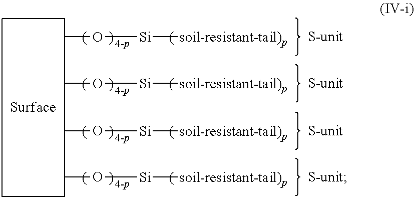

In several embodiments, p is an integer selected from 1, 2, or 3. In several embodiments, Surface (IV-i) may be represented by any one of Surfaces (I), (II) or (III), where p is 1. Surface (IV-i) represents a configuration where the Si atom includes one or more tails (e.g., 1, 2, or 3). In several embodiments, each instance of the “soil-resistant-tail” is independently represented by -alkyl-X-haloakyl. In several embodiments, each instance of the “soil-resistant-tail” is independently represented by —(CH₂)ₙ—X—(CF₂)ₘ—CF₃. In several embodiments, each instance of the “soil-resistant-tail” is independently represented by —(CH₂)ₙ—(CF₂)ₘ—CF₃.

Several embodiments pertain to a soil resistant substrate (e.g., diamond, lens, etc.) prepared by a method as disclosed elsewhere herein. Several embodiments pertain to a method of preparing a soil resistant substrate (e.g., a soil resistant diamond, lens, etc.). In several embodiments, as disclosed elsewhere herein and as shown in FIGS. 2A, 2B and 5, a soil resistant substrate (e.g., diamond or other substrate) is prepared by plasma treating a surface of a raw substrate (e.g., diamond surface) to provide a precursor surface (of the substrate, e.g., diamond, etc.) having a precursor surface (e.g., a precursor diamond surface). In several embodiments, as disclosed elsewhere herein, the precursor surface (e.g., precursor diamond surface) is chemically different than the surface of the raw substrate (e.g., the raw diamond). In several embodiments, as disclosed elsewhere herein, the precursor surface (e.g., precursor diamond surface) has different physical properties than the surface of the raw substrate (e.g., the raw diamond).

In several embodiments, the method comprises annealing the precursor surface (e.g., precursor diamond surface) to provide a reactive substrate surface (e.g., reactive diamond surface). In several embodiments, the reactive surface (e.g., reactive diamond surface) is chemically different from the precursor surface (e.g., the precursor diamond surface). In several embodiments, the reactive substrate surface (e.g., reactive diamond surface) is physically different than the precursor surface. In several embodiments, the reactive substrate surface has sufficient density of reactive groups to provide a soil-resistant layer and/or coating substantially free from defects. In several embodiments, the reactive substrate surface has a density of reactive groups (e.g., reactive oxygen species) that is equal to or at least about: 1 reactive group per nm², 2 reactive groups per nm², 3 reactive groups per nm², 4 reactive groups per nm², or ranges including and/or spanning the aforementioned values.

In several embodiments, as disclosed elsewhere herein, to prepare the coated surface, a reactive substrate surface (e.g., reactive diamond surface) is exposed to a silanizing agent (e.g., silanizing group) comprising an S-unit. In several embodiments, the silanizing agent (e.g., silanizing group) comprises the following structure: (LG)₃Si-(soil-resistant-tail), where the soil-resistant-tail is as disclosed elsewhere herein. In several embodiments, each instance of LG is a leaving group independently selected from alkyl, alkoxy, and a halogen. In several embodiments, the silanizing agent comprises the following structure: (LG)₃Si-alkyl-X-haloalkyl, where X, alkyl, and haloalkyl are as disclosed elsewhere herein. In several embodiments, the silanizing agent comprises the following structure: (LG)₃Si(CH₂)ₙ—X—(CF₂)ₘCF₃. In several embodiments, each of “X”, “n”, and “m” are as disclosed elsewhere herein. In several embodiments, the silanizing agent comprises the following structure: (LG)₃Si(CH₂)ₙ(CF₂)ₘCF₃.

In several embodiments, the silanizing group (e.g., silanizing agent) is selected from the group consisting of heptafluoroisopropoxypropyltrichlorosilane, heptafluoroisopropoxypropyltrimethoxysilane, bis(nonafluorohexyldimethylsiloxy)methyl-silylethyldimethylchlorosilane, tridecafluoro-2-(tridecafluorohexyl)decyltrichlorosilane, heneicocyl-1,1,2,2-tetrahydrodecyltrichlorosilane, (tridecafluoro-1,1,2,2-tetrahydrooctyl)trichlorosilane, (tridecafluoro-1,1,2,2-tetrahydrooctyl)methyldichlorosilane, (tridecafluoro-1,1,2,2-tetrahydrooctyl)dimethylchlorosilane, (tridecafluoro-1,1,2,2-tetrahydrooctyl)trimethoxysilane, (tridecafluoro-1,1,2,2-tetrahydrooctyl)triethoxysilane, (heptadecafluoro-1,1,2,2-tetrahydrodecyl)trichlorosilane, (heptadecafluoro-1,1,2,2-tetrahydrodecyl)methyldichlorosilane, (heptadecafluoro-1,1,2,2-tetrahydrodecyl)dimethylchlorosilane, (heptadecafluoro-1,1,2,2-tetrahydrodecyl)trimethoxysilane, (heptadecafluoro-1,1,2,2-tetrahydrodecyl)triethoxysilane, and combinations of any of the foregoing.

In several embodiments, the anti-soiling coating is durable. In several embodiments, the contact angle of the anti-soiling coating remains within 10% of its original value after equal to or at least about: 50 abrasion cycles, 100 abrasion cycles, 200 abrasion cycles, or ranges including and/or spanning the aforementioned values. In several embodiments, the contact angle of the anti-soiling coating remains within 5%, 10%, 15%, or 20% (or ranges including and/or spanning the aforementioned values) of its original value after equal to or at least about 50 abrasion cycles, 100 abrasion cycles, 200 abrasion cycles, or ranges including and/or spanning the aforementioned values. An abrasion cycle is performed by rubbing a substrate against a cotton cloth in a forward and backward direction a distance of 10 substrate lengths (e.g., 10 cm for a 1 cm substrate) in each direction (as disclosed in the Examples). In several embodiments, the abrasion cycle is performed using slight finger pressure (sufficient to allow movement of the substrate against the cloth without the cloth slipping away from the substrate or finger).

In several embodiments, the treated gemstones (e.g., molecularly functionalized diamonds) disclosed herein retain their brilliance, fire, luster, and scintillation for longer periods of time (e.g., for days, weeks longer, and months longer) than untreated gemstones. Moreover, whereas the current mechanical or chemical cleaning methods do not completely remove all contaminants, the molecular layers as disclosed herein protect the gemstone surface from grease accumulation, granting optical quality.

Surprisingly, in several embodiments, it has been found that the brilliance, fire, luster, and/or scintillation is not significantly affected by silanization with a silane unit. In several embodiments, any decrease in the brilliance, fire, luster, and/or scintillation is imperceptible to a trained jeweler using their naked eye or an eye loupe. In several embodiments, any decrease in the brilliance, fire, luster, and/or scintillation may be measured spectroscopically (using light intensity measures, absorption, transmittance, etc.). In several embodiments, after functionalization with a silane unit as disclosed elsewhere herein, the functionalized (e.g., silanized) diamond's brilliance is decreased relative to the raw diamond by less than or equal to about: 15%, 10%, 5%, 2.5%, 1.0%, 0%, or ranges including and/or spanning the aforementioned values. In several embodiments, after functionalization with a silane unit as disclosed elsewhere herein, the functionalized (e.g., silanized) diamond's fire is decreased relative to the raw diamond by less than or equal to about: 15%, 10%, 5%, 2.5%, 1.0%, 0%, or ranges including and/or spanning the aforementioned values. In several embodiments, after functionalization with a silane unit as disclosed elsewhere herein, the functionalized (e.g., silanized) diamond's luster is decreased relative to the raw diamond by less than or equal to about: 15%, 10%, 5%, 2.5%, 1.0%, 0%, or ranges including and/or spanning the aforementioned values. In several embodiments, after functionalization with a silane unit as disclosed elsewhere herein, the functionalized (e.g., silanized) diamond's scintillation is decreased relative to the raw diamond by less than or equal to about: 15%, 10%, 5%, 2.5%, 1.0%, 0%, or ranges including and/or spanning the aforementioned values.

Surprisingly, in certain implementations, it has been found that the brilliance, fire, luster, and/or scintillation is improved after silanization with a silane unit.

In several embodiments, the treated gemstones (e.g., diamonds) retain showroom quality shine under normal wearing conditions for a period of at least about: 1 week, 2 weeks, a month, 3 months, 6 months, or ranges including and/or spanning the aforementioned values. This surprising and unexpected improvement is significant considering that untreated diamonds begin to accumulate matter that dulls their appearance substantially immediately after cleaning.

In several embodiments, a treated substrate (e.g., coated substrate, such as a diamond) retains equal to or at least about: 70%, 80%, 90%, 95%, 99%, or 100% (or ranges including and/or spanning the aforementioned values) of its brilliance under normal wearing conditions for a given period of time. In several embodiments, relative to a natural gemstone (e.g., a natural diamond), the brilliance of the treated gemstone (e.g., diamonds) is improved by: 1.0%, 2.5%, 5.0%, 10%, 20%, 30%, 40%, or 50% (or ranges including and/or spanning the aforementioned values) under equivalent normal wearing conditions for a given period of time. For instance, if a treated diamond and untreated diamond are placed in substantially equivalent wear conditions and, after a given period of wear of one month, if the brilliance of the normal diamond has decreased and the brilliance of the treated diamond has decreased to a smaller degree, this would be quantified as an improvement in brilliance for the treated diamond. If the brilliance of the untreated diamond decreased by 35%, but the brilliance of the treated diamond only decreased by 5%, this would be quantified as a 30% improvement in brilliance over the given period of time (one month). In several embodiments, the period of time after which brilliance is measured is a period of equal to or at least about: 1 week, 2 weeks, a month, 2 months, 3 months, or ranges including and/or spanning the aforementioned values.

In several embodiments, a treated gemstone (e.g., coated gemstone or diamond) retains equal to or at least about: 70%, 80%, 90%, 95%, 99%, or 100% (or ranges including and/or spanning the aforementioned values) of its fire under normal wearing conditions for a given period of time. In several embodiments, relative to a natural gemstone (e.g., a natural diamond), the fire of the treated gemstone (e.g., diamonds) is improved by: 2.5%, 5.0%, 10%, 20%, 30%, 40%, or 50% (or ranges including and/or spanning the aforementioned values) under equivalent normal wearing conditions for a given period of time. For instance, if a treated diamond and untreated diamond are placed in substantially equivalent wear conditions and, after a given period of wear of one month, if the fire of the normal diamond has decreased and the fire of the treated diamond has decreased to a smaller degree, this would be quantified as an improvement in fire for the treated diamond. If the fire of the untreated diamond decreased by 35%, but the fire of the treated diamond only decreased by 5%, this would be quantified as a 30% improvement in fire over the given period of time (one month). In several embodiments, the period of time after which fire is measured is a period of equal to or at least about: 1 week, 2 weeks, a month, 2 months, 3 months, or ranges including and/or spanning the aforementioned values.

In several embodiments, a treated substrate (e.g., coated substrate, coated diamond, etc.) retains equal to or at least about: 70%, 80%, 90%, 95%, 99%, or 100% (or ranges including and/or spanning the aforementioned values) of its clarity under normal wearing conditions for a given period of time. In several embodiments, relative to a natural gemstone (e.g., a natural diamond), the clarity of the treated gemstone (e.g., diamonds) is improved by: 2.5%, 5.0%, 10%, 20%, 30%, 40%, or 50% (or ranges including and/or spanning the aforementioned values) under equivalent normal wearing conditions for a given period of time. For instance, if a treated diamond and untreated diamond are placed in substantially equivalent wear conditions and, after a given period of wear of one month, if the clarity of the normal diamond has decreased and the clarity of the treated diamond has decreased to a smaller degree, this would be quantified as an improvement in clarity for the treated diamond. If the clarity of the untreated diamond decreased by 35%, but the clarity of the treated diamond only decreased by 5%, this would be quantified as a 30% improvement in clarity over the given period of time (one month). In several embodiments, the period of time after which clarity is measured is a period of equal to or at least about: 1 week, 2 weeks, a month, 2 months, 3 months, or ranges including and/or spanning the aforementioned values.

In several embodiments, where the substrate is clear or transparent (e.g., a glasses lens, diamond, etc.) the treated substrate (e.g., coated substrate) retains equal to or at least about: 70%, 80%, 90%, 95%, 99%, or 100% (or ranges including and/or spanning the aforementioned values) of its transmissivity under normal wearing conditions for a given period of time. In several embodiments, relative to a untreated substrate, the transmissivity of the treated substrate is improved by: 2.5%, 5.0%, 10%, 20%, 30%, 40%, or 50% (or ranges including and/or spanning the aforementioned values) under equivalent normal wearing conditions for a given period of time. For instance, where a treated substrate is untreated substrate in substantially equivalent wear conditions (e.g., are placed side-by-side in a set of binoculars), after a given period of normal use, if the transmissivity of the untreated substrate has decreased by 20% and the transmissivity of the treated diamond has not decreased, this would be quantified as a 20% improvement in transmissivity for the treated substrate. In several embodiments, the period of time after which transmissivity is measured is a period of equal to or at least about: 1 week, 2 weeks, a month, 2 months, 3 months, or ranges including and/or spanning the aforementioned values.

In several embodiments, advantageously, the coatings disclosed herein may be removed from the substrate using heat. For example, in several embodiments, users may want to recover a diamond in its substantially original form after coating. In several embodiments, users may want to reapply a fresh coating once the original coating has worn off partially. In several embodiments, the coating removal process is performed at a temperature equal to or at least about: 450° C., 500° C., 550° C., 600° C., or ranges including and/or spanning the aforementioned values. In several embodiments, the coating removal process is performed for a period of time equal to or less than about: 30 minutes, 60 minutes, 1.5 hours, 2.0 hours, 4 hours, 5 hours, 6 hours, or ranges including and/or spanning the aforementioned values. In several embodiments, after removal, the coating can be refreshed using the methods disclosed elsewhere herein (plasma treatment, annealing, silanization, etc.).

In several embodiments, a diamond is a polished carbon crystal of any weight, color, clarity, or cut. In several embodiments, the diamond is a slice. In several embodiments, the diamond is lab grown. In several embodiments, the diamond is natural. In several embodiments, the diamond is a powder coating applied to a grinding wheel, silicon wafer, or other flat or textured surface. In several embodiments, the diamond is a constituent of a composite. In several embodiments, the diamond is a nanoparticle. In several embodiments, the diamond contains defect sites including nitrogen vacancy centers, silicon vacancy centers, boron doping, or other chemical or physical inclusion. Henceforth these variations of diamond are collectively referred to as “diamond”.

As disclosed elsewhere herein, in some embodiments, the gemstone is diamond. In several embodiments, using S-units as disclosed herein, maintains the original look of the diamond (or other gemstone or other substrate). In several embodiments, the clarity and/or color of diamond is substantially unchanged after a molecular coating is applied. For example, in some embodiments, a diamond that has a color grade of D will remain a color grade of D after coating. In several embodiments, a diamond that has a clarity of VVS₂ will remain a clarity of VVS₂ after coating.

In several embodiments, a coating is applied to a diamond. In several embodiments, the coating is a monolayer. In several embodiments, chemical agents are not used to form a sub-monolayer or pre-coating prior to adding the monolayer on the diamond surface.

In several embodiments, as disclosed elsewhere herein, applying coatings to an untreated diamond results in poor adhesion, so the diamond must be modified in order to achieve suitable durability for a non-stick, self-cleaning, or lipophobic application. In several embodiments, chemical coatings will not attach to the surface of the diamond, chemically or physically, without an engineered modification of the diamond crystal interface. Some embodiments of such engineered modifications are disclosed herein. In several embodiments, the engineered modification includes functionalizing the diamond surface with an organic constituent. In several embodiments, the diamond surface composition is changed to reflect the chemistry of an organic constituent. In several embodiments, those chemical functionalities include molecules that form chemical bonds to other chemical entities (that normally would not react with a diamond surface). In several embodiments, the added chemical functionalities include molecules that form chemical bonds to specific surfaces or are generalized that chemically connect to any surface. Such surface/molecule coupling reactions could be anything for which an appropriate connection is prepared. In several embodiments, these include “click-chemistry” molecular coupling (e.g., azide/alkyne pairs), molecular silanes (e.g., R—Si(LG)₃) reacting with oxygen-containing chemical species functionality, carbenes reacting with carbon-hydrogen functionality, or supramolecular interactions such as between a surface-bound adamantyl or carborane group and a cyclodextrin molecule or modified-cyclodextrin molecule. The nature of the organic component (e.g., R) can be any chemical functionality including aliphatic, aromatic carbon chains or other molecules, or themselves include functional groups for subsequent modification.

Diamond is non-uniformly chemically functional, with a mixture of surface states consisting of an uncharacterized mixture of hydrogen, oxygen (hydroxyl, carboxyl), or various carbon-containing species. One or multiple of these species is not amenable to chemical functionalization. An uncontrolled chemical interface prevents deposition of well-controlled, durable, stable, and functional chemical surface coatings. One or more embodiments disclosed herein solve these or other problems.

In several embodiments, diamond is pretreated with chemical and physical modification to transform one surface chemical identity into another. In several embodiments, the diamond is treated to convert a larger fraction of the surface to hydrogen termination. In several embodiments, the diamond is pretreated to convert a larger fraction of the surface to oxygen containing species (e.g. hydroxyl, carboxyl).

In several embodiments, hydrogen surface termination ratio is increased by application of hydrogen plasma in vacuum. In several embodiments, the hydrogen surface termination ratio is increased by polishing in the presence of a hydrocarbon lubricant. In several embodiments, the hydrogen termination is functionalized using a carbene generated in situ by elimination of diazomethane groups.

In several embodiments, the oxygen species (e.g., reactive oxygen species) surface ratio is increased by application of chemical treatment. In several embodiments, this chemical treatment is a mixture of sulfuric acid and hydrogen peroxide. In several embodiments, this mixture of acid and peroxide cleans and removes adventitious species as a pretreatment of the diamond crystal and can remove a thin outermost diamond layer. In several embodiments, this mixture of acid and peroxide increases the ratio of oxygen-containing species at the diamond surface. In several embodiments, this ratio is measured by the water contact angle of a water droplet sitting on a diamond surface. In several embodiments, higher proportions of oxygen species lead to a lower water contact angle (e.g., <40°). Higher proportions of hydrogen or carbon termination will lead to a higher water contact angle (e.g., >40°, <80°)

In several embodiments, diamonds are treated (e.g., pretreated) with a hydrogen plasma. In several embodiments, plasma treatment renders the surface rich in hydrogen species. In several embodiments, the surface will be temporarily highly hydrophilic but will return to WCA˜60° over several days. In several embodiments, hydrogen can be replaced with hydroxide by treatment of diamond surfaces in a furnace at >500° C. under wet nitrogen flow at ˜10 psi. In several embodiments, a hydrogen-rich surface will be converted to hydroxyl-rich or to other similar and related species.

In several embodiments, molecules containing silane or siloxane functional groups are used to modify diamond surfaces (e.g., silanizing agents, as disclosed elsewhere herein). In several embodiments, the molecules have trichlorosilane functional groups, or methoxy/ethoxy derivatives of the same. In several embodiments, the organic portion (e.g., “R”) of the molecule is optionally substituted alkyl. In some embodiments the organic portion of the molecule is a linear alkyl chain of variable length. In some embodiments the organic portion of the molecule is a branched alkyl chain of variable length. In some embodiments the organic portion of the molecule is a linear fluorocarbon chain. In some embodiments the organic portion of the molecule is a branched fluorocarbon chain. In some embodiments the molecule is dipodal with multiple silane functional groups. In some embodiments chemical reactions convert trichlorosilane groups to silanol, and then to alkyloxy groups. In some embodiments molecules contain alkyl functionality. In several embodiments, chemicals (e.g., silane) are attached to untreated diamond. In several embodiments, chemicals are attached to treated diamond (e.g., pretreated with plasma as disclosed elsewhere herein). In several embodiments, chemicals are attached to diamond with an adhesion layer. In several embodiments, chemicals are attached to an applied or engraved texture. In several embodiments, an atomic layer deposition is performed on the hydroxyl or directly functionalized by any species capable of reacting with surface hydroxyl groups. In several embodiments, the hydroxyl-rich surface is used to attach a secondary attachment layer.

In several embodiments, diamond surfaces are treated with chemical agents to functionalize the diamond surface. In several embodiments, an adhesion layer rich in adhesion promoters is applied via atomic layer deposition (ALD), Aluminum oxide (Al₂O₃) deposited using trimethyl aluminum (TMA) and water, at 0.1-50 nm thickness to the oxygen-rich diamond. In several embodiments, ALD is used to deposit silicon dioxide, hafnia, metallic layers (e.g. copper, gold), or other ALD-compatible material to the diamond surface.

In several embodiments, the ALD process can be used to impart color or texture to the diamond surface. In several embodiments, the adhesion layer coating can be used as the final coating. In several embodiments, texture can be engraved or etched using chemical or physical means. In several embodiments, the adhesion layer coating can be further chemically functionalized. In several embodiments, the adhesion coating can be applied to the monolayer coating. In several embodiments, all coatings can be applied in consecutive order forming multilayer stacks.

In several embodiments, the surface of a gemstone (e.g., diamond) after chemically modification using a silane with a perfluorinated tail are hydrophobic. In several embodiments, the contact angle for water on the surface of a silane-treated gemstone (e.g., silanized diamond having a silane with a perfluorinated tail) is greater than or equal to about: 80°, 85°, 90°, 95°, 100°, 105°, 110°, 115°, 120°, 125°, 130°, or ranges including and/or spanning the aforementioned values. In several embodiments, the contact angle for water on the treated (e.g., plasma treated and silanized) gemstone is equal to or at least about 50%, 75%, 90%, 95%, 99% greater than the contact angle for water on the gemstone before treatment (or ranges including and/or spanning the aforementioned values). In several embodiments, the contact angle for water on the treated gemstone is changed relative to the contact angle for water on the untreated gemstone by equal to or at least about: 30°, 35°, 40°, 45°, 50°, 55°, 60°, 65°, 70°, 75°, 80°, 85°, 90°, 95°, 100°, 105°, 110°, 115°, 120°, 125°, 130°, or ranges including and/or spanning the aforementioned values.

In several embodiments, the contact angle for water on a raw diamond (e.g., an untreated, cut diamond that has not been chemically modified) is equal to or at least about: 40°, 45°, 50°, 55°, 60°, 65°, 70°, 75°, 80°, 90°, 95°, 100°, or ranges including and/or spanning the aforementioned values.

In several embodiments, the contact angle for water on a precursor diamond (e.g., a diamond that has been subject to plasma treatment but not annealing) is equal to or at least about: 60°, 65°, 70°, 75°, 80°, 85°, 90°, 95°, 100°, or ranges including and/or spanning the aforementioned values.

In several embodiments, the contact angle for water on a reactive gemstone (e.g., that has been plasma treated and water annealed) is equal to or at least about: 10°, 20°, 30°, 35°, 40°, 45°, 50°, 55°, 60°, 65°, 70°, 75°, or ranges including and/or spanning the aforementioned values. In several embodiments, the contact angle for water on a plasma treated and water annealed gemstone is equal to or at least about: 10°, 20°, 30°, 35°, 40°, 45°, 50°, 55°, 60°, 65°, 70°, 75°, or ranges including and/or spanning the aforementioned values.

In several embodiments, surfaces chemically modified by fluorinated carbon chains are superhydrophobic with water contact angles >120°. Superhydrophobicity improves contamination release and anti-smudge characteristics while enhancing cleaning. In several embodiments, superhydrophobicity is caused by a chemical monolayer, multilayer, or mesh on diamond. In several embodiments, superhydrophobicity is caused by texturing on diamond. In several embodiments, superhydrophobicity is caused by a combination of chemical monolayer, multilayer, mesh and texturing on diamond.

In some embodiments replacing the fluorinated carbon chains with non-fluorinated hydrocarbons eliminates fluorine-based waste. In several embodiments, surfaces chemically modified with non-fluorinated carbon chains are hydrophobic with water contact angles >100°. The hydrophobicity improves contamination release and anti-smudge characteristics while enhancing cleaning. In some embodiments fluorinated chains are environmentally undesirable. In some embodiments an alkyl-based hydrocarbon chain or aryl-based ring systems. In some embodiments the fluorinated chains are replaced with perchlorinated carbon chains.

### EXAMPLES

Reagents and solvents were acquired from commercial sources without additional purification. (Heptadecafluoro-1,1,2,2-tetrahydrodecyl) trichlorosilane was obtained from Gelest. A slotted two inch wafer dipper was obtained from Shame Master. Diamonds were acquired from Jean Dousset diamonds and were table diamond cut 3 mm stones. Water contact angle measurements were performed using a One Attension—Theta Goniometer. Plasma treatment was performed using a Tergio table top plasma generator. An electric furnace was built in-house.

### Example 1: Plasma Treatment and Water Vapor Annealing Procedure

Upon receipt, a new unprocessed diamond (e.g., a raw diamond) was unpackaged. The raw diamond was placed within a fabricated, aluminum diamond seat in the goniometer. The water contact angle was measured using the One Attension-Theta Goniometer from Biolin Scientific. The droplet size used for contact angle measurement was 0.75 μL, though smaller droplets (0.5 μL) could also be used. The contact angle of water for the diamond was roughly 35°-50°. Upon positioning the diamond in the diamond seat, a water droplet was placed on the diamond. A photograph of the droplet on the diamond was taken.

At that time, the raw diamond was plasma treated to generate a precursor diamond surface. The raw diamond was placed in a quartz plasma chamber of the plasma generating device. The plasma chamber was evacuated. A gas flow of oxygen and/or hydrogen was used to generate the reactive surface. The gas flow rate was set to 99 standard cubic centimeters per minute (sccm) for the desired gas. The pressure in the chamber was adjusted to about 320 mtorr and the gas flow rate was adjusted to 0 sccm. The plasma generating device is then operated to generate clean diamond surface. Sample conditions include: High Pressure 02 plasma, direct, 150 W, 20 sccm, 2 min; 02 Plasma, remote, 100 W, 10 sccm, 15 min; H₂ plasma, remote, 150 W, 20 sccm, 30 min. FIG. 5 provides an exemplary plasma treatment program (as does Step A of Scheme 1, FIGS. 2A and 2B). The contact angle of the precursor diamond surface was measured.

The plasma-cleaned diamond surface was then annealed using water. To form OH terminated diamond surfaces, the CH-terminated diamond samples were subjected to water vapor (wet) annealing. As mentioned above, FIG. 2B shows the plasma treatment of a raw diamond in Step A. After the precursor diamond surface is generated through plasma treatment, the diamond surface is annealed using water. The annealing treatment (Step B of FIG. 2B) was performed under an atmosphere of nitrogen bubbled through ultrapure water in a quartz tube in an electric furnace (as shown in FIG. 3). The annealing process is also shown in FIG. 5 (and in Step B of FIGS. 2A and 2B). The water saturated nitrogen is passed through the furnace at elevated temperatures (e.g., 300-700° C. for 1 h to 2 h). The flow of the nitrogen gas was 400 sccm. After annealing, a reactive diamond surface results.

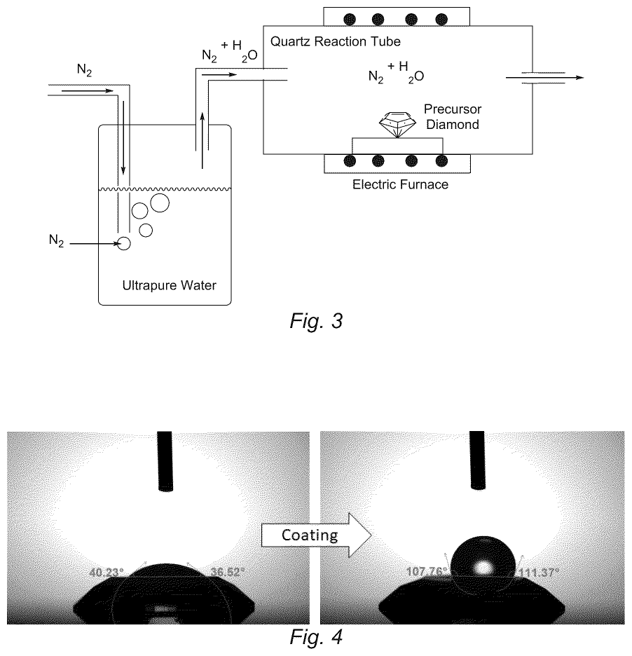

The water contact angle of the reactive diamond surface was measured using the One Attension-Theta Goniometer from Biolin Scientific. The droplet size used for contact angle measurement was 0.75 μL. Upon positioning the reactive diamond in the diamond seat, a water droplet was placed on the reactive diamond. A photograph of the droplet on the diamond was taken. The left panel of FIG. 4 shows a photograph of a drop of water on the reactive diamond surface. As shown, the contact angle of the water droplet is less than 45°, indicating a hydrophilic surface.

### Example 2: Low Temperature Preparation of the Silanized Surface Having Anti-Soiling Properties

To prepare a functionalized diamond surface the following procedures were performed. A solution of isooctane and carbon tetrachloride was prepared. Magnesium sulfate was added to dry the solution of any water. The dry solution was decanted away from the magnesium sulfate. The dry solution was covered and placed in a freezer to provide a chilled solution. At that time, (heptadecafluoro-1,1,2,2-tetrahydrodecyl) trichlorosilane (FDTS) was added to the solution. The FDTS was allowed to mix in the organic solution for 10 minutes in the freezer. At that time, the reactive diamond were dipped into the solution using a Teflon dipper. The reactive diamond was submerged and the reaction solution was placed back in the freezer for at least 30 minutes. After 30 minutes, the diamond samples were removed from the freezer. The diamonds were removed from the solution and rinsed with ethanol. Other coated substrates can be prepared using different substrates or different silanizing agents in view of these procedures.

The water contact angle of the functionalized diamond surface was measured using the One Attension-Theta Goniometer from Biolin Scientific. The droplet size used for contact angle measurement was 0.75 μL. Upon positioning the functionalized diamond in the diamond seat, a water droplet was placed on the functionalized diamond. A photograph of the droplet on the diamond was taken. The right panel of FIG. 4 shows a photograph of a drop of water on the functionalized diamond surface. As shown, the contact angle of the water droplet is over 105°, indicating a hydrophobic surface.

### Example 3: Desorption of the Silanized Surface Having Anti-Soiling Properties

Advantageously, the silanized monolayer coating of the diamond can be removed (to afford the raw diamond) and/or regenerated. For instance, if after a period of time, the monolayer surface has degraded, it can be removed completely and regenerated. To remove the monolayer, the diamonds are placed in a furnace at 550° C. for 0.5 hrs or 500° C. for 2 hrs. Retreatment can then be performed using the procedures of Examples 1 and 2.

### Example 4: Abrasion Testing (Coating Durability)

To test the covalent coating's durability, the table surface of a diamond (3 mm in diameter) was rubbed against a cotton fabric along a 3 cm length of the cloth. One abrasion cycle was equal to one round trip of rubbing the diamond with finger on the straight line of cotton cloth (6 total cm). The diamond was subject to 100 abrasion cycles, then an additional 100 abrasion cycles (200 abrasion cycles total). Each abrasion cycle used a constant pressure provided by a finger-tip. After the first 100 abrasive cycles, the water contact angle after was measured. The water contact angle after was measured after the total of 200 cycles as well. Because one abrasion cycle covered a total of 6 cm distance, this was equivalent to 20 individual rubs across the table (e.g., the top face) of the diamond. Thus, 20 abrasion cycles is equivalent to 20 round trips, or 400 times rubbing the entire surface of the table of the diamond. 200 abrasion cycles was equivalent to 10 ×20 round trip or 4000 times of rubbing the entire table surface of the diamond. Assuming consumers average 10 times of rubbing exposure per day, then if coating survives 10×20 abrasion cycles, the coating is estimated to last 400 days, longer than 1 year. The contact angle of water after coating was approximately 1000 to 1150 contact angle after coating. The contact angle of water after 100 abrasion cycles was approximately 900 to 105°. The contact angle of water after 100 abrasion cycles was approximately 850 to 100°.

What is claimed is:

1. A soil resistant diamond comprising:
a jewelry grade diamond gemstone having an anti-soiling surface coating, the anti-soiling surface coating comprising a monolayer, the diamond surface and monolayer being represented by Surface (I): 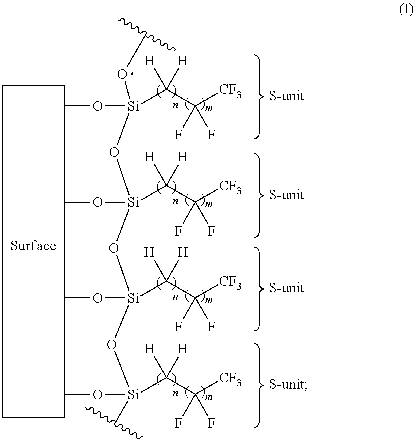
where
n is an integer selected from 0, 1, 2, 3, or 4;
m is an integer ranging from 1 to 15;
wherein the soil resistant diamond is prepared by:
plasma treating a surface of a raw diamond to provide a precursor diamond having a precursor diamond surface, the precursor diamond surface being chemically different than the surface of the raw diamond;
annealing the precursor diamond to provide a reactive diamond having a reactive diamond surface, the reactive diamond surface being different from the precursor diamond surface; and
exposing the reactive diamond surface to a silanizing agent comprising an S-unit;
wherein each “S-unit” is a silane unit consisting of Si(CH₂)ₙ(CF₂)ₘCF₃.

2. The soil resistant diamond of claim 1, wherein the surface of the raw diamond comprises hydroxyl groups, carbonyl groups, carboxylic acid groups, epoxide groups, C—H groups, and C—C groups, as represented in Surface (I-r) by groups A¹, A², A³, A⁴, A⁵, and A⁶, respectively:

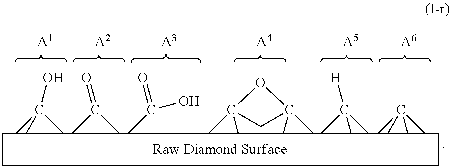

3. The soil resistant diamond of claim 1 or 2, wherein a contact angle for water on the surface of the raw diamond ranges from 50° to 80°.

4. The soil resistant diamond of any one of claims 1 to 3, wherein the precursor diamond surface comprises a ratio of A¹ and A⁶ groups relative to a total number of surface groups A¹ to A⁶ that is higher than a ratio of A¹ and A⁶ groups relative to a total number of surface groups A¹ to A⁶ for the raw diamond surface.

5. The soil resistant diamond of any one of claims 1 to 4, wherein a contact angle for water on the precursor diamond surface ranges from 400 to 80°.

6. The soil resistant diamond of any one of claims 1 to 5, wherein the reactive diamond surface comprises a ratio of A¹ groups relative to a total number of surface groups A¹ to A⁶ that is higher than a ratio of A¹ groups relative to a total number of surface groups A¹ to A⁶ for the precursor diamond surface.

7. The soil resistant diamond of any one of claims 1 to 6, wherein a contact angle for water on the reactive diamond surface ranges from 10° to 40°

8. The soil resistant diamond of any one of claims 1 to 6, wherein n is 2.

9. The soil resistant diamond of any one of claims 1 to 6, wherein n is 2.

10. The soil resistant diamond of any one of claims 1 to 9, wherein m is between 6 and 12.

11. The soil resistant diamond of any one of claims 1 to 9, wherein m is 8.

12. The soil resistant diamond of any one of claims 1 to 11, wherein each nm² of the soil resistant diamond surface comprises equal to or at least 2 S-units.

13. The soil resistant diamond of any one of claims 1 to 12, wherein the Surface (I) is further represented by Surface (I-i):

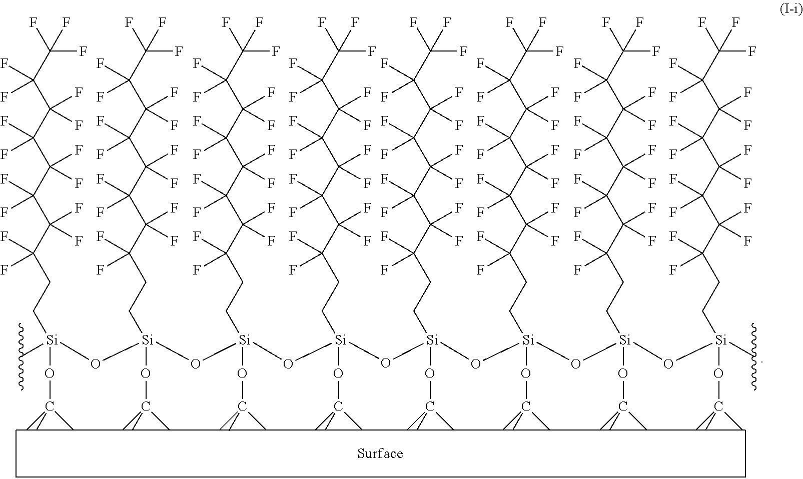

14. A soil resistant lens comprising:
a lens having an anti-soiling surface coating, the anti-soiling surface coating comprising a monolayer, the lens surface and monolayer being represented by Surface (I): 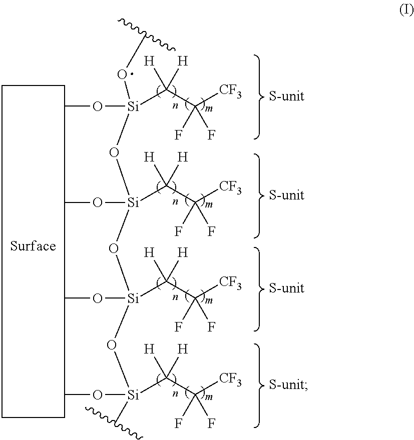
where
n is an integer selected from 0, 1, 2, 3, or 4;
m is an integer ranging from 1 to 15;
wherein the soil resistant lens is prepared by:
plasma treating a surface of an untreated lens to provide a precursor lens having a precursor lens surface, the precursor lens surface being chemically different than the surface of the untreated lens;
annealing the precursor lens to provide a reactive lens having a reactive lens surface, the reactive lens surface being different from the precursor lens surface; and
exposing the reactive lens surface to a silanizing agent comprising an S-unit;
wherein each “S-unit” is a silane unit comprising of Si(CH₂)ₙ(CF₂)ₘCF₃.

15. A molecularly coated surface comprising, Formula I:
S-A [symbol] T)ₚ Formula I
where
S represents a surface of a gemstone and -A(-T)ₚ represents the molecular coating;
A is an silane or siloxane covalently bonded to S;
T is a pendant tail moiety bonded to A;
p is an integer between 1 and 5; and
wherein the coated surface has different physical properties and/or chemical properties than the surface prior to coating.

16. The surface of claim 15, wherein T is an C₁-C₁₀ alkyl or C₁-C₁₀ perfluoroalkyl.

17. The surface of claim 15 or 16, wherein T is selected from the group consisting of heptafluoroisopropoxypropyl, nonafluorohexyl, tridecafluorohexyl, trifluoromethyl, or combinations thereof.

18. The surface of any one of claims 15 to 17, wherein the surface is that of a diamond.

19. A method of preparing the surface of any one of claims 15 to 18, comprising exposing the surface to a reagent selected from: heptafluoroisopropoxypropyltrichlorosilane, heptafluoroisopropoxypropyltrimethoxysilane, bis(nonafluorohexyldimethylsiloxy)methyl-silylethyldimethylchlorosilane, tridecafluoro-2-(tridecafluorohexyl)decyltrichlorosilane, heneicocyl-1,1,2,2-tetrahydrodecyltrichlorosilane, (tridecafluoro-1,1,2,2-tetrahydrooctyl)trichlorosilane, (tridecafluoro-1,1,2,2-tetrahydrooctyl)methyldichlorosilane, (tridecafluoro-1,1,2,2-tetrahydrooctyl)dimethylchlorosilane, (tridecafluoro-1,1,2,2-tetrahydrooctyl)trimethoxysilane, (tridecafluoro-1,1,2,2-tetrahydrooctyl)triethoxysilane, (heptadecafluoro-1,1,2,2-tetrahydrodecyl)trichlorosilane, (heptadecafluoro-1,1,2,2-tetrahydrodecyl)methyldichlorosilane, (heptadecafluoro-1,1,2,2-tetrahydrodecyl)dimethylchlorosilane, (heptadecafluoro-1,1,2,2-tetrahydrodecyl)trimethoxysilane, (heptadecafluoro-1,1,2,2-tetrahydrodecyl)triethoxysilane, or combinations thereof.

20. The method of claim 19, comprising exposing the surface to plasma treatment prior to exposure to the reagent.

21. A diamond comprising the surface of any one of claims 1 to 17.
